(19) United States
(12) Patent Application Publication
(10) Pub. No.: US 2007/0239569 A1
(43) Pub. Date: Oct. 11, 2007

(54) Systems and methods for managing assets

(76) Inventors: Michael Lucas, Calabasas, CA (US); Matt Truong, Boyds, MD (US)

Correspondence Address: NATH & ASSOCIATES, 112 South West Street, Alexandria, VA, 22314, US

(21) Appl. No.: 11/703,207

(22) Filed: Feb. 7, 2007

Related U.S. Application Data
(63) Continuation-in-part of application No. 10/873,183, filed on Jun. 23, 2004.
Application No. 10/873,183 is a continuation of application No. 09/799,879, filed on Mar. 7, 2001, now Pat. No. 6,996,538.
(60) Provisional application No. 60/187,389, filed on Mar. 7, 2000.
(60) Provisional application No. 60/765,737, filed on Feb. 7, 2006.
(60) Provisional application No. 60/780,289, filed on Mar. 9, 2006.
(60) Provisional application No. 60/786,371, filed on Mar. 28, 2006.

(51) Int. Cl. G06Q 10/00

(52) U.S. Cl. 705/28; 700/115

(57) ABSTRACT

The inventive subject matter relates to systems, methods, apparatus, and computer program products relating to tracking and managing assets of an enterprise, such as non-fixed, capital assets. More particularly, the invention relates preferably to using radio frequency identification (RFID) tags to track, manage, and maintain mobile or portable assets of a enterprise, such as shopping cart assets.

This application is a continuation-in-part of U.S. patent application Ser. No. 10/873,183, filed Jun. 23, 2004, which is a continuation of U.S. patent application Ser. No. 09/799,879, filed Mar. 7, 2001, now U.S. Pat. No. 6,998,538, which claims the benefit of U.S. Provisional Patent Application No. 60/187,389, filed Mar. 7, 2000, the contents of which are hereby incorporated by reference in their entirety. Further, this application claims the benefit of U.S. Provisional Patent Application No. 60/765,737, filed Feb. 7, 2006; No. 60/780,289, filed Mar. 9, 2006; and No. 60/786,371, filed Mar. 28, 2006, the contents of which are hereby incorporated by reference in their entirety.

### BACKGROUND OF THE INVENTIVE SUBJECT MATTER

1. Field of Inventive Subject Matter

The inventive subject matter relates to systems, methods, apparatus, and computer program products relating to tracking and managing assets of an enterprise, such as non-fixed, capital assets. More particularly, the invention relates preferably to using radio frequency identification (RFID) tags to track, manage, and maintain mobile or portable assets of a enterprise, such as shopping cart assets.

2. Background

Asset management is very important as today's enterprises make efforts to streamline operations to reduce overall operation costs. However, currently there are few tools available that allow enterprises to accurately track, maintain, and properly distribute mobile or portable assets such as equipment and capital assets. Many enterprises spend large amounts on equipment and capital assets, but have few options available to track and manage their assets and ensure that their resources are being used as efficiently as possible.

Many enterprises must manage hardware components, which are entered as capital assets and shelved either for back-up inventory, for replacement of failed, obsolete or out for repair equipment, or for future upgrades in technology. Company employees, for example engineers, often operate on a reaction basis; that is they replace assets upon failure or when technology has been advanced to warrant or require a replacement. A problem which occurs in this regard is that efficiently managing capital assets requires asset location identification, as many enterprises have multiple sites and in many instances, the whereabouts of assets are not known absent taking a costly and time-consuming physical inventory.

Another common problem is that presently in many busy enterprises, equipment and other mobile or portable assets are received from various vendors into a central warehouse location where the item may never be opened, catalogued, or placed in inventory, but are instead taken directly by an employee to another location for use or installation. No complete record of this process is made; the installation date, the exact location, manufacturer, model, serial number, life expectancy of the item, and so forth, to name but a few important data items, are often not recorded at all or incompletely.

Further, many enterprises would benefit from reducing the amount of assets not in use, e.g. in the warehouse on “standby,” as it would better define the inventory needed based on life expectancy, for example, of the assets tracked. Some enterprises, such as cable television companies, suffer a large percentage of value reduction for hardware component assets that become outdated before being placed into service, because they were not needed. As technology continues to advance, the goal of such enterprises is to keep minimal inventory in stock for repair, backup or replacement.

Finally, many enterprises experience the problem of only reacting to repair or replacement needs, instead of preventative maintenance. If the information about assets, as discussed above, was accessible, particularly easily accessible via a software business application, such enterprises would be able to maintain more accurate budgets such as an IT budget, would be able to submit accurate and complete information to enterprise finance managers, and would be able to repair and resell assets scheduled for replacement while such assets are classified as “working” hardware, rather than classified as lost, obsolete, or “repair necessary”.

Because of these deficiencies, neither a business' engineering group, nor its finance group, of such an enterprise have a sufficient idea of what items are obsolete or otherwise should be marked for “asset disposition,” i.e. assets which must be discarded. Unfortunately, such asset items often remain on the balance sheet and are scheduled for depreciation over the time period required by accounting standards, rather than used in an immediate write off expense, which would be permitted if the item was properly tracked and shown as discarded, obsolete, or sold.

With such asset information, enterprise finance groups would also be able to improve their forecasts, as the enterprise and its working units, such as finance groups and the IT department, would have a better idea of the hardware requirements necessary for the upcoming year(s). And finally, the enterprise would be able to reduce inventory, thus reducing the amount of write downs because of the value placed on the technology upon receipt and during the course of an accounting period.

Similar issues exist in other environments where the enterprise relies on ready-use of mobile assets. For instance in a warehouse environment, various containers are often moved from one location to the next, with some uncertainty arising regarding a present location of a specific container at any given time. As more employees move containers from one location to another, or move groups of containers so as to access a specific container, the likelihood of a container being misplaced increases.

Applications of RFID technology are wide ranging and include detecting objects as they pass near to a sensor, uniquely identifying a specific tag and associated asset, and placing data relating to the tag into an RFID reader for later recovery. The process of reading and communicating with an RFED tag generally includes bringing the tag in proximity to an RFID sensor.

In one aspect, the RFID tags are active tags with an internal power source and emit a constant RF signal (or alternatively pulsed beacon). The RFID readers then detect the tag's emitted RF signal when the signal is within the range of the reader's emitted RF field (or receive range), and the readers receive and process the RF signal emitted by the tags. Thus, the reader detects the presence of an RFID tag by detecting its RF signal, and processes the received RF signal to accurately determine the unique identification code of the tag.

Alternatively, in other conventional systems, the RFID tags are passive until activated by the radio frequency field of an RFID sensor, at which point they become active. The RFID tag detects the presence of the field of the reader, and subsequently activates to send data, using various forms or protocols of hand shake occur between the tag and the reader, in order to exchange data. All of this communication between the tag's transponder and the sensor is performed using radio frequency energy of some kind. When multiple RFID tags are involved, anti-collision protocols are employed in order to multiplex or provide multiple accesses to the readers by the multiple tags. The main advantages of an RFID sensor and transponder system over the other forms of RFID tagging include (i) communication can occur within comparatively harsh operating environments; and (ii) the communication range between the sensor and transponder can be significant even when the RF frequencies are within the power limitations of the Federal Communications Commission (FCC) rules concerning unlicensed transmitters.

Accordingly, RFID technology is useful for several applications, especially those relating to security and asset management. For example, in an application where enhanced security is desired, RFID systems using electromagnetic energy with very low frequency are attractive since the very low frequency energy tends to suffer low losses from shielding materials such as metal boxes, aluminum foil, curtains, and the like.

Thus, with improvements in RFID technology, there is a particular need for systems, methods, apparatus, and computer program products to better track and manage mobile and portable assets of an enterprise.

In a particular, exemplary embodiment discussed throughout this application, efficiently managing shopping cart assets similarly requires location identification, as many enterprises have multiple sites and, currently, the whereabouts of shopping cart assets within and outside business premises are not known unless a costly and time-consuming physical inventory is taken, and carts which have been taken away from business premises are recovered.

In addition, many enterprises would benefit from reducing the quantity of shopping cart assets which must be maintained “on hand,” as better tracking would better define the inventory needed. As technology continues to advance and the cost of capital assets continues to rise, the goal of many enterprises is to keep minimal shopping cart inventory in stock.

Because of the deficiencies in prior art described above in asset management, particularly shopping cart asset management, an enterprise does not efficiently manage its assets and maintains too large a stock-on-hand of assets such as shopping carts. Unfortunately, such asset items, although not well tracked, often remain on the balance sheet and are scheduled for depreciation over the time period required by accounting standards, rather than used in an immediate write off expense, which would be permitted if the item was properly tracked and recorded as lost when that circumstance arises. And finally, if such assets were better managed, the enterprise would be able to reduce inventory, thus reducing the amount of write downs during the course of an accounting period.

Further, enterprise store design, advertising, and promotions groups would be better able to focus their efforts on effective store floor plan layout, product placement, advertising, and promotions when having the ability to track and correlate shopper behavior, including movement and timing of movement within a store, product selection for purchase, and use of promotions.

Similar issues exist in other environments where the enterprise relies on ready-use of mobile assets. For instance in a warehouse environment, various containers are often moved from one location to the next, with some uncertainty arising regarding a present location of a specific container at any given time. As more employees move containers from one location to another, or move groups of containers so as to access a specific container, the likelihood of a container being misplaced increases.

Finally, in the specific context of businesses utilizing shopping carts, there is a need for the ability to track the location of a shopping cart in order to (1) determine movement of the cart within the business premises, (2) correlate cart presence and tracked movement with point of sale (POS) data such as customer purchases, (3) reduce or prevent unauthorized removal of this business asset from business premises, and (4) permit authorized removal of this business asset from business premises and tracking to a anticipated location. In this context, there is great value to the business in being able to monitor customers' shopping experiences and buying trends, and to arrange inventory location and availability to meet customer demand.

Thus, the ability of a store to obtain information about one or even a few retail store(s) does not provide sufficient data to forecast the optimal inventory location and availability needed to determine the buying trends of consumers, whether, for example, within a particular geographical area or for a particular category of goods.

There is a need for manufacturers, distributors and retailers to be able to retrieve data from multiple stores, which will provide information that will enable them to position their product on a shelf with more visibility, improve the location of promotional displays for sales events, shift entire product categories should other trends in markets so indicate, or a combination thereof.

To be most effective, such data would reflect the effect on sales of, for example, locating goods from the cereal and/or bread category in close proximity to the diary and/or fruit and vegetable departments. The synergistic relationship between such products in use may produce an increase in sales of one or the other, or both, where there is a proximal in store location, as compared to sales locations a greater distance apart.

Thus, with improvements in RFID technology, there is a particular need for systems, methods, apparatus, and computer program products to better track and manage mobile and portable assets of an enterprise. In particular, there are multiple reasons that shopping carts which are better tracked and managed can improve the operation of a business utilizing shopping carts, both extend the service lifetime of such assets and to aid the business in better serving the needs of its customers.

### SUMMARY OF THE INVENTIVE SUBJECT MATTER

The inventive subject matter relates to a system, and corresponding method for managing assets of an enterprise, comprising:

a. a plurality of managed asset units, each tagged with a unique identifier;

b. a first asset reader, having an associated first location coverage area, for reading a tagged asset;

c. a first interface for entering or reading identity information of a user at the first location;

d. a second asset reader, having an associated second location coverage area, for reading a tagged asset;

e. a second interface for entering or reading identity information of a user at the second location;

f. at least one data server, configured for:
i. storing the unique identifiers and associated data describing the asset corresponding thereto,
ii. storing data relating to a plurality of asset units,
iii. storing identity information, and permissions, roles, or both assigned to at least one user, and
iv. determining location information for an asset unit based on the coverage areas of the asset readers; and

g. a client device which is connected to the data server, and includes a display device configured to display:
i. a plurality of user-selectable data queries corresponding to stored asset unit data, and
ii. search results for stored asset unit data that corresponds with a user-selectable data query.

### BRIEF DESCRIPTION OF THE DRAWINGS

FIG. 1 is a drawing which depicts communications channels between a networked server and network devices located at one or more other enterprise locations, according to one aspect of the inventive subject matter.

FIG. 2 is a drawing which depicts communications channels between a networked server and fully integrated network devices located at one or more other enterprise locations, and at outside manufacturer(s), supplier(s), and distributor(s), according to one aspect of the inventive subject matter.

FIG. 3 is a drawing which depicts communications channels between a networked server, a single network device located at one other enterprise location, and network devices located at outside manufacturer(s), supplier(s), and distributor(s), according to one aspect of the inventive subject matter.

FIG. 4 is a drawing which depicts communications channels between a networked server, a single network device located at one enterprise location, two other network devices located at satellite locations, and network devices located at outside manufacturer(s), supplier(s), and distributor(s), according to one aspect of the inventive subject matter.

FIG. 5 is a drawing which depicts GPS-aided, RFID asset tracking at a non-enterprise site, according to one aspect of the inventive subject matter.

FIG. 6 is a drawing which depicts asset reader asset tracking at enterprise and non-enterprise sites, according to one aspect of the inventive subject matter.

FIG. 7 is a drawing which depicts RFID tracking of a storage rack and individual asset items, according to one aspect of the inventive subject matter.

FIG. 8 is a drawing which depicts RFID tracking of a storage rack and individual asset items using multiple readers configured to provide precise three dimensional asset tracking, according to one aspect of the inventive subject matter.

FIG. 9A is a drawing which depicts RFID tracking of a storage rack and individual asset items using dual shelf antennas, according to one aspect of the inventive subject matter.

FIG. 9B is a drawing which depicts RFID tracking of a storage rack and individual asset items using cabinet wall antennas, according to one aspect of the inventive subject matter.

FIG. 10 is a screenshot which depicts the Life Cycle page of an exemplary internet-based asset tracking and management system, according to one aspect of the inventive subject matter.

FIG. 11 is a screenshot which depicts the Alerts page of an exemplary internet-based asset tracking and management system, according to one aspect of the inventive subject matter.

FIG. 12 is a screenshot which depicts the user-selected toolbar of the Alerts page of an exemplary internet-based asset tracking and management system, according to one aspect of the inventive subject matter.

FIG. 13A is a drawing which depicts a top view of an exemplary RFID antenna detection grid having a series of RFID antennas with overlapping detection areas, according to one aspect of the inventive subject matter.

FIG. 13B is a drawing which depicts a top view of an exemplary RFID antenna detection grid having a series of RFID antennas with non-overlapping detection areas, according to one aspect of the inventive subject matter.

FIG. 14 is a drawing which depicts a top view of an exemplary business location having product display units interspersed with access aisles, and having an overhead RFID antenna detection grid, according to one aspect of the inventive subject matter.

### DETAILED DESCRIPTION OF THE INVENTIVE SUBJECT MATTER

### Definitions

“Capital asset” or “fixed asset” as used herein refers to a class of property, including durable goods, equipment, buildings and land, which are purchased for continued and long-term use in earning profit in a business, and which are written off against profits over their anticipated life by charging depreciation expenses. A shopping cart within the meaning of one aspect of the inventive subject matter is a “capital asset” or “fixed asset.”

“Managed asset” as used herein refers to a class of assets, including “capital assets,” and encompasses durable goods, including shopping carts, vehicles, and equipment, which are not affixed to land or other fixed property. “Managed asset unit” as used herein refers to a quantity designated as a standard of measurement for a managed asset. Exemplary managed asset units of increasing quantities include a single item; a box or package; a carton; a pallet; and a shipping container. The specific quantity designated as a unit for a managed asset is determined by, for example, the size, cost, and packaging of the particular asset.

“Tagged asset” as used herein refers to a managed asset to which is affixed a tag associated with an identifier which is unique to the asset. Exemplary tags include, without limitation, bar code, RFID, and newer technologies such as IEEE standard 1902.1, which is also known as RuBee. RuBee is expected to give retailers and manufacturers an alternative to RFID for many applications, especially item-level tracking efforts, upon its expected release in 2007 or 2008.

“Enterprise” as used herein refers broadly to a purposeful or industrious undertaking. The term encompasses not only business undertakings, but also includes, for example, such non-business undertakings as managing the assets of a family or a home.

“User” as used herein refers to a person, machine, or mechanized process which manipulates a managed asset or managed asset unit.

“Biometric identification device” as used herein refers to a device which detects essentially unique biometric characteristics such fingerprints, retinal scans, genetic features, and so forth. A preferred biometric identification device of the present invention is a fingerprint capture device. Such a fingerprint reader preferably makes use of a holographic element, provides for a high contrast image, and rejects residual latent fingerprints that remain on the detector surface. Such a device preferably complies with the geometric image accuracy specified in appendix F of the Electronic Fingerprint Transmission Specification for the Criminal Justice Information services (CJIS), ISO 19794-2, and/or the requirements for ten-print slap capture requirements for the Department of Homeland Security (DHS).

### The Inventive Subject Matter

Asset Management. The inventive subject matter relates to systems, methods, apparatus, and computer program products relating to tracking and managing assets of an enterprise, such as non-fixed, capital assets. More particularly, the invention relates preferably to using radio frequency identification (RFID) tags to track, manage, and maintain mobile or portable assets in a enterprise having one or more facilities that house mobile or portable assets.

The inventive subject matter, particularly utilizing RFID, provides a solution to asset tracking and management. The implementation of a new system appears to be the limiting issue at present, as most companies do not want a change in the way they conduct their business unless the labor requirement is minimal and the return on investment is substantial enough to make an impact. An asset item affixed with an RFID tag which can hold the information described herein provides an efficient and cost effective solution. It also provides for minimal labor interaction for tracking, for example when RFID readers/antennae are in place at each entry/exit, or as shown in the drawings, on or around storage facilities.

Many enterprise employees, because of concerns with security, sensitivity and equipment value, already have employee identification cards which allow accessibility to facilities and equipment based on their pre-determined roles or permissions granted by enterprise administration. These roles or permissions may require some record-keeping, and thus provide entry and exit reports, as well as some level of security, but such systems are not currently used in conjunction with asset tracking for inventory asset management as disclosed by Applicant herein.

In one aspect of the inventive subject matter, asset items received by a shipping/receiving group would be recorded (date, time, and other asset details) when the item reached the warehouse. This would then allow the inventive systems, methods, and/or software to keep a record of each item including manufacturer, model, serial number, description, expected life cycle, cost, in-stock date, availability in stock, repair history, damage history, in-use date, out-of-service date(s), remaining life cycle predicted, date returned, date transferred, obsolescence date, sale date, total quantity in stock, or a combination thereof.

As each such asset item is removed from the warehouse, the inventive systems, methods, and/or software records both the date and time of exit, and employee information from the employee removing the item, either from an identification card or entry of the required data. If the employee removing the item is not permitted to do so, under enterprise administration rules, an electronic notification may, in one embodiment, be sent to a supervisor or other authority within the company. On the other hand, if the action is permitted, an electronic notification, such as a text message, may be sent to the employee requesting further information such as the destination for asset item(s) removed, which may be selected as all or individually, depending on number of locations the items are intended for.

Thereafter, in another embodiment, if the employee does not respond to an inquiry, a report or event notification may be generated for a supervisor or other employee responsible for accounting for the asset.

In one aspect, if an asset destination is entered, then upon entry into the “hub end” or “head end” of an enterprise, the item will be reconciled with the destination entry and a “first in use” date entered.

The same method may be implemented upon a removal of an item. When departing a “hub end” or “head end” facility, an employee may be prompted with a selection of pre-determined possibilities such as: “out for repair”, “obsolete”, “item to be sold”, etc. In both examples above, the system, or software, is providing asset tracking and accountability as to the disposition of each item.

In another aspect, the inventive systems, methods, software, and apparatus will function to direct employees to the location of an asset item scheduled for replacement, repair or maintenance. The specific location where the asset is stored may be found, for example, through a wireless device such as a telephone with RFID capabilities, which can locate the unique identifier associated with the asset. This will reduce the amount of time currently spent searching for equipment, or the location of items to be replaced or repaired.

Another benefit of the above procedure is that, for example, if an employee fails to input a destination code, the RFID tag would be read upon entry at the destination and that entry event recorded, for example, to indicate as “first in use” thus automatically accomplishing the same end as the act of the employee.

An employee could also be made accountable for those items that are removed when no destination is entered. Having such information automatically entered, raising the level of employee accountability, or both, would be expected to positively affect, for example, enterprise accounting and engineering departments.

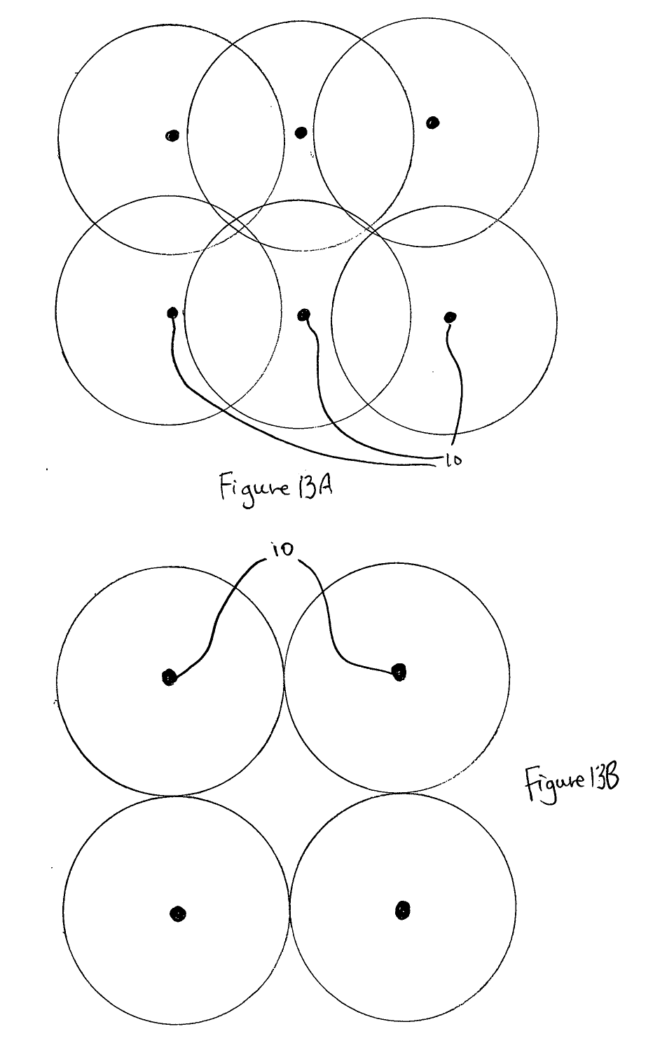

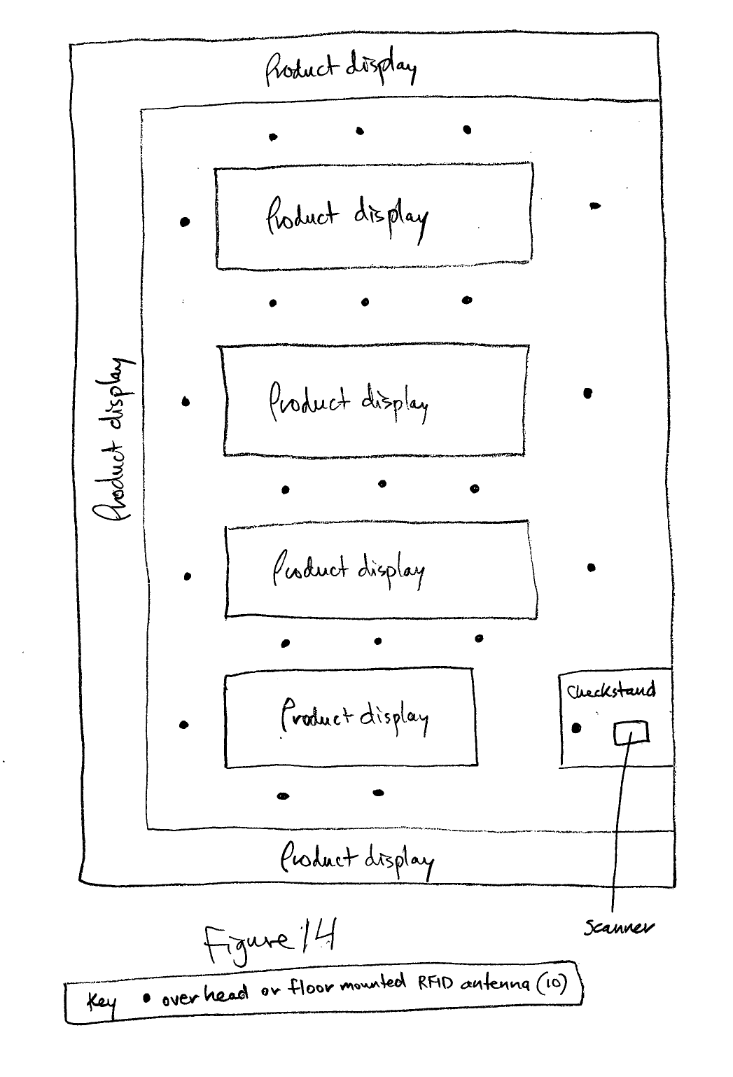

The inventive subject matter, particularly utilizing RFID, provides a solution to asset tracking and management. The implementation of a new system appears to be the limiting issue at present, as most companies do not want a change in the way they conduct their business unless the labor requirement is minimal and the return on investment is substantial enough to make an impact. An asset item affixed with an RFID tag which can hold the information described herein provides an efficient and cost effective solution. It also provides for minimal labor interaction for tracking, for example when RFID readers/antennae are in place at various locations throughout a product sales floor, and at each checkstand, as shown in FIGS. 13-14.

Shopping cart asset management. In one aspect, the inventive subject matter relates to systems, methods, apparatus, and computer program products using radio frequency identification (RFID) tags to track, manage, and maintain shopping cart assets in a enterprise having one or more facilities that utilize shopping carts. Additionally, in this aspect the inventive subject matter relates to tracking and correlating data relating to customer movements within a store, customer purchases, customer utilization of advertised and/or promoted products, and customer buying decisions, to assess the effectiveness of business floor plan layouts, to assess the effectiveness of product displays, and to assess the effectiveness of advertising and promotions. Further, the inventive subject matter relates to an automated check-out system and method which correlates scanned product purchase data with known product weight to verify check-out scan accuracy and reduce scan errors. Finally, the inventive subject matter relates to a shopping cart inventory, security, and tracking system which optionally is programmable to permit carts to leave business premises.

The shopping cart is an asset that, when tracked, does not impose upon the consumer the collection of personal data for potential exploitation by third parties. The asset itself is tracked throughout the business environment. When a check-out event occurs, an inventive system executes a comparison between the final purchase and the traffic movement within the store. In one aspect, such data is then analyzed to determine, for example, the following information regarding the customer's shopping experience:
Did the consumer stop in front of a particular category of goods and make a purchase?
Did the customer stop in front of a particular category of goods without purchasing?
Did the consumer spend only a few seconds at a particular location, inferring that he/she knew what item was wanted and/or that such item was easily accessible?
Did the consumer follow a detectable shopping pattern and/or redeem specific coupons in the store, inferring that the customer came into the store with a specific shopping list?

Loyalty cards have been used to limited effect for this purpose for many years, and do provide data on the buying habits of the consumer. However, loyalty cards cannot demonstrate the decision process that goes into purchasing, for example, a specific brand. Thus, the consumer may bypass the purchase of one brand item and purchase another because of a promotional display and/or the positioning of the product, and/or some additional factor(s) well known to the skilled retail marketing artisan. Retailers would be able to charge for positioning of space based on true traffic counts by aisle, section, department, or the like.

### Inventive Systems

Thus, the inventive subject matter relates to a system for managing assets of an enterprise, comprising:

a. a plurality of managed asset units, each tagged with a unique identifier;

b. a first asset reader, having an associated first location coverage area, for reading a tagged asset;

c. a first interface for entering or reading identity information of a user at the first location;

d. a second asset reader, having an associated second location coverage area, for reading a tagged asset;

e. a second interface for entering or reading identity information of a user at the second location;

f. at least one data server, configured for:
i. storing the unique identifiers and associated data describing the asset corresponding thereto,
ii. storing data relating to a plurality of asset units,
iii. storing identity information, and permissions, roles, or both assigned to at least one user, and
iv. determining location information for an asset unit based on the coverage areas of the asset readers; and

g. a client device which is connected to the data server, and includes a display device configured to display:
i. a plurality of user-selectable data queries corresponding to stored asset unit data, and
ii. search results for stored asset unit data that corresponds with a user-selectable data query.

In an alternate aspect, the inventive system further comprises at least one data server, configured for:

i. storing POS-associated data describing the products purchased by each customer,

ii. storing POS-associated data which is further associated with customer data maintained in a customer loyalty program or other unique customer identifier database,

iii. storing customer identity information, and permissions and roles, or both, assigned to the customer,

iv. correlating time-matched location information for a shopping cart asset with POS data, and optionally

v. correlating customer data with the time-matched location information for a shopping cart asset and the POS data.

Many enterprise employees, because of concerns with security, sensitivity and equipment value, already have employee identification cards which allow accessibility to facilities and equipment based on their pre-determined roles or permissions granted by enterprise administration. These roles or permissions may require some record-keeping, and thus provide entry and exit reports, as well as some level of security, but such systems are not currently used in conjunction with asset tracking for inventory asset management as disclosed by Applicant herein.

In one aspect of the inventive subject matter, asset items received by a shipping/receiving group would be recorded (date, time, and other asset details) when the item reached the warehouse. This would then allow the inventive systems, methods, and/or software to keep a record of each item including manufacturer, model, serial number, description, expected life cycle, cost, in-stock date, availability in stock, repair history, damage history, in-use date, out-of-service date(s), remaining life cycle predicted, date returned, date transferred, obsolescence date, sale date, total quantity in stock, or a combination thereof.

As each such asset item is removed from the warehouse or another location, the inventive systems, methods, and/or software records both the date and time of exit, and employee information from the employee removing the item, either from an identification card or entry of the required data. If the employee removing the item is not permitted to do so, under enterprise administration rules, an electronic notification may, in one embodiment, be sent to a supervisor or other authority within the company. On the other hand, if the action is permitted, an electronic notification, such as a text message, may be sent to the employee requesting further information such as the destination for asset item(s) removed, which may be selected as all or individually, depending on number of locations the items are intended for.

Thereafter, in another embodiment, if the employee does not respond to an inquiry, a report or event notification may be generated for a supervisor or other employee responsible for accounting for the asset.

In one aspect, if an asset destination is entered, then upon entry into the “hub end” or “head end” of an enterprise, the item will be reconciled with the destination entry and a “first in use” date entered.

The same method may be implemented upon a removal of an item. When departing a “hub end” or “head end” facility, an employee may be prompted with a selection of pre-determined possibilities such as: “out for repair”, “obsolete”, “item to be sold”, etc. In both examples above, the system, or software, is providing asset tracking and accountability as to the disposition of each item.

In another aspect, the inventive systems, methods, software, and apparatus will function to direct employees to the location of an asset item scheduled for replacement, repair or maintenance. The specific location where the asset is stored may be found, for example, through a wireless device such as a telephone with RFID capabilities, which can locate the unique identifier associated with the asset. This will reduce the amount of time currently spent searching for equipment, or the location of items to be replaced or repaired.

Another benefit of the above procedure is that, for example, if an employee fails to input a destination code, the RFID tag would be read upon entry at the destination and that entry event recorded, for example, to indicate as “first in use” thus automatically accomplishing the same end as the act of the employee.

An employee could also be made accountable for those items that are removed when no destination is entered. Having such information automatically entered, raising the level of employee accountability, or both, would be expected to positively affect, for example, enterprise accounting and engineering departments.

Additional aspects and embodiments of the inventive systems are described in the claims appended hereto.

Similarly, an exemplary system for RFID-based asset tracking as it pertains to shopping carts or the like, comprises:

(a) an RFID tag affixed to a shopping cart;

(b) a plurality of RFID antennas, located to track the shopping cart as it moves throughout the store and provide a record of one, some, or all of the following exemplary events:
total time the shopping cart was used within the store,
record date/time stamp of the shopping cart movement throughout the store,
record date/time stamp of the shopping cart at check-out register to compare to Point of Sale (POS) data captured at checkout
record how long a customer stayed at a particular location within the store;

(c) an RFID antenna located at a checkout area; and

(d) a device or system for synchronizing POS data with the RFID tag on the cart during checkout.

In one aspect, the RFID tag affixed to a shopping cart is placed on the front of the cart.

In another aspect, the RFID tag optionally is covered, such as by an advertising message on the tag. Covering the tag provides two obvious benefits to the business: first, to conceal the tag and second to produce revenue. Antenna covers optionally would have promotional sleeves inserted on the exterior of the antenna, for ease of changing advertising materials. Optionally, the tag may be covered with an electronic display, to promote specific brands within an aisle or provide store messages, preferably but not necessarily, keyed to the store location of the shopping cart.

In one aspect, the total time the shopping cart is used within a store will provide an overall average of the time spent in the store by consumers. A start point for such timing feature would be when the shopping cart enters the range of a first antenna, while the end time would be when the cart is physically in the checkout area.

Recording a date/time stamp of the shopping cart, and consumer, movement throughout the store, such as what aisles are visited, how long is spent in front of specific sections, such as a product category or brand, is expected to yield the following useful event data, in which the data collected from the POS may be compared to a movement report to provide further data mining such as:

i) how long did the consumer spend at a product category location before making a purchasing decision;

ii) how long did the consumer spend in the store;

iii) did the consumer use a coupon, which may infer involvement of the coupon in the purchasing decision;

iv) what aisles, locations, or sections did the consumer pass through;

v) what was the average time spent in each aisle, location, or section;

vi) did the consumer pass by a specific category without stopping;

vii) did the consumer take advantage of the end isle display;

viii) did the consumer purchase an item from a promotional display;

ix) how long did the customer spend at a product category location considering a purchase that was not made;

x) analysis of the effectiveness of particular types of product displays;

xi) analysis of the effectiveness of particular types of in-store advertising;

xii) analysis of the effectiveness of particular types of in-store promotions;

xiii) analysis of the effectiveness of particular store floor plan layouts;

xiv) analysis of employee productivity, such as a checker for example;

xv) analysis of speed of checkout processing; and

xvi) determination of correlation between ease and speed of shopping and checkout experience, and customer satisfaction.

In relation to the latter, it will be necessary to survey customer satisfaction following the visit to the store.

At least one RFID antenna would be located at the check-out area, such as a checkstand, where the cart is unloaded and can be coordinated with POS data. It is important that the data from the POS can and should be synchronized with the RFID tag data on the cart as a new sale begins. The antenna being read at the unloading area would be read for identity as soon as scanning of the first item begins, after the previous sale has been closed out. It is expected that a “no cart” feature would be incorporated into the system, to provide a checker with the opportunity to over-ride the system in order to correlate each set of movement data with the correct POS data, allowing for instances where the customer does not use a shopping cart, or for other reasons does not have a functional tracking tag.

### Inventive Methods

The inventive subject matter relates to a method for managing assets of an enterprise, comprising the steps of:

a. providing a plurality of managed asset units, each tagged with a unique identifier, wherein the unique identifiers, associated data describing the asset corresponding thereto, and data relating to a plurality of asset units are stored in at least one data server;

b. reading an asset tag associated with a managed asset unit with a first asset reader having an associated first location coverage area;

c. entering or reading identity information of a user at the first location, wherein the identity information, and permissions, roles, or both assigned to at least one user are stored in the at least one data server;

d. reading an asset tag associated with a managed asset unit with a second asset reader having an associated second location coverage area;

e. entering or reading identity information of a user at the second location;

f. determining location information for an asset unit based on the coverage areas of the asset readers; and

g. outputting a plurality of user-selectable data queries corresponding to stored asset unit data, search results for stored asset unit data that corresponds with a user-selectable data query, or a combination thereof.

In an alternate aspect, the inventive method further comprises the additional steps of:

i. storing POS-associated data describing the products purchased by each customer,

ii. storing POS-associated data which is further associated with customer data maintained in a customer loyalty program or other unique customer identifier database,

iii. storing customer identity information, and permissions and roles, or both, assigned to the customer,

iv. correlating time-matched location information for a shopping cart asset with POS data, and optionally

v. correlating customer data with the time-matched location information for a shopping cart asset and the POS data.

### EXAMPLES AND EMBODIMENTS OF THE INVENTIVE SUBJECT MATTER

The following examples are illustrative of the inventive subject matter and are not intended to be limitations thereon.

### Example 1

### Exemplary Shopping Cart Tracking and Management

A shopping cart is tagged with an RFID tag having a unique identifier. The RFID tag is readable by an RFID reader attached to a system having a database to correlate each unique identifier with information relating to the shopping cart, such as the owner of the cart, the “base” location of the cart, and the like. The RFID reader system is any one of those known to a skilled RFID systems engineer, including but not limited to a preferred long range system such as the “Wi-max” system.

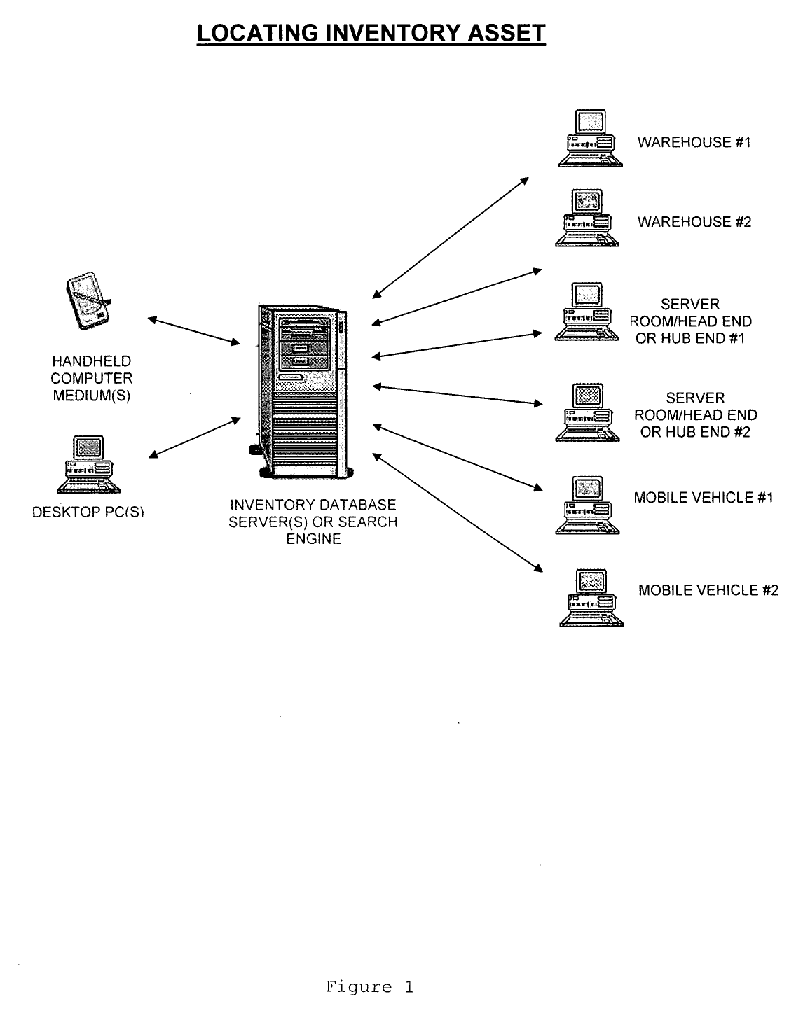

At a business location of the owner of the shopping cart asset, a plurality of RFID reader antennae are installed in a configuration so as to permit contact with tagged assets. In exemplary FIG. 1A, the reader antennae are located so that tagged assets are never out of range of at least one antenna and contact is continuous. In exemplary FIG. 1B, the reader antennae are located so that tagged assets may temporarily be out of range of the readers, but must periodically pass within range of at least one reader as the asset is moved about the business location. How large the gaps between antennae, and thus how detailed the information which may be recorded regarding cart location, is optionally varied by the user based on factors such as the amount of event data detail desired to be collected, and cost.

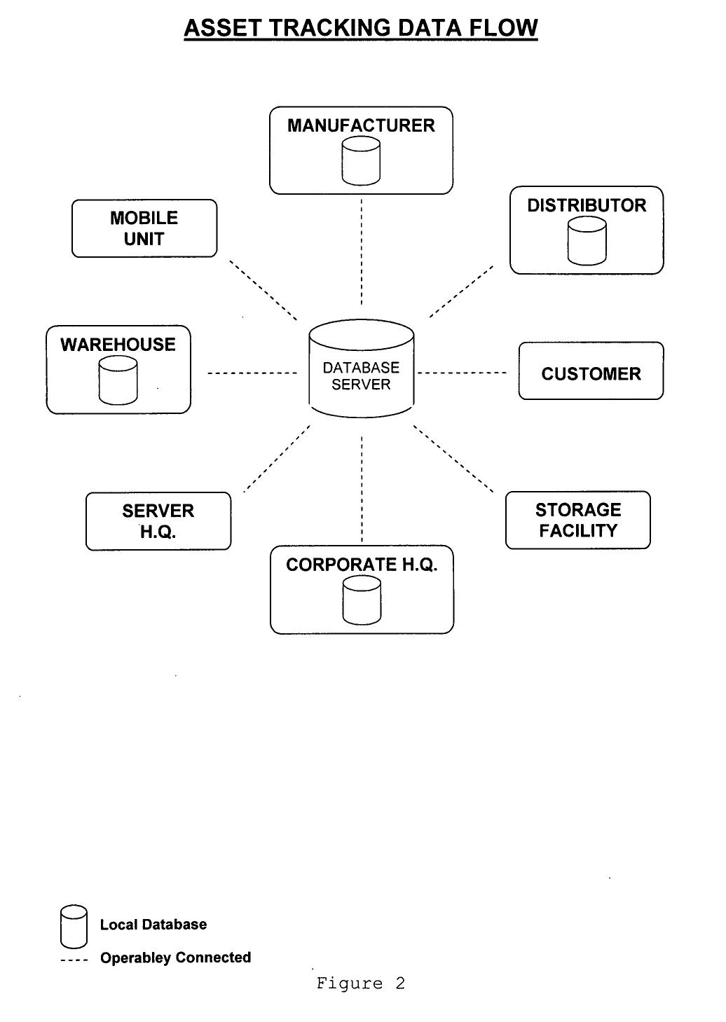

At periodic time intervals, for example once per second, as a customer moves about the business location, one or more of the plurality of RFID reader antennae detect the presence of each tagged asset and event data is recorded for each such detection event. Over the course of a customer's visit to the business location, a visit history profile is developed, mapping where on the business premises the customer, or at least the cart, was, at what time(s), and for how long. Optionally, the plurality of FRID antennae would also detect and record the presence and movement of RFID tags affixed to products. Thus, in the exemplary embodiment shown in FIG. 2, the plurality of antennae are located over the aisles of the business premises and over the checkstand.

When the customer checks out, his/her purchases are optionally recorded, and a Point-of-Sale (POS) report generated. Similarly, when the customer goes to the checkout area, a report of the cart movements is optionally generated. The two reports so generated are optionally compared and/or correlated to determine what the customer purchased, how long the customer spent in areas where purchases were made, and how long the customer spent and where on the business premises he/she was when no purchase was made. With this data, a skilled artisan in the field of product marketing is in a position to improve marketing for particular products by targeting some goods for greater promotion and by changing the marketing strategy for other goods. Such data is optionally, and preferably, also linked to the loyalty card of the customer, permitting improved marketing opportunities to that customer.

Once the customer has checked out and is ready to leave the business premises, the business operator optionally may make a decision as to whether or not to permit the customer to continue to use the shopping cart off the business premises. Some businesses may, as a customer service, wish to permit the customer to take his/her purchases home in a shopping cart, for example in the cases of the elderly or otherwise impaired, or simply those without their own transportation.

If the business operator wishes to prevent a cart leaving the premises without authorization, a number of wheel-locking systems are commercially available. However, such systems are primarily designed to prevent cart theft, and to Applicants' knowledge are uniformly non-discriminating in use. That is, one or more wheels of the cart lock upon reaching a certain point, generally the business premises perimeter, and there is no provision for preventing locking in order to allow the cart to be taken off-site.

In an alternate aspect of the inventive subject matter, such a wheel-locking mechanism is controllable. In one aspect, such control is exercised by a store employee having the appropriate permissions or roles to access the system. In a preferred embodiment, the control of a wheel-locking mechanism is optionally linked to a customer loyalty card database, in which the customer may be permitted off-site use of shopping carts. In this aspect, the inventive system would serve the function of “checking out” a shopping cart to a particular customer. In another aspect, the number of carts permitted to be checked out to one customer would be limited, and the customer would optionally be required to return a borrowed shopping cart before taking another.

Utilizing long range tracking capability, the business owner would be able to track its tagged shopping cart assets off-site. In addition, the business owner, or its cart collection agent, would be able to locate its tagged shopping cart assets and decide whether to collect and return them, or wait for the customer to have the opportunity to do so. Such tagging and tracking capability, having a unique identifier for each cart, would also make is possible for each cart to be located at will and returned to its true owner.

### Example 2

### RFID-Enabled, Weight-Based Automated Checkout System

In another aspect of the inventive subject matter, a system for automating and streamlining customer checkout from a business premises is contemplated. Such a system would comprise the following elements:
a plurality of matched shopping carts of known weight, or alternately a plurality of shopping carts, each tagged with an RFID tag having a unique identifier and each of known weight recorded in a database and associated with the corresponding unique RFID tag,
a scale or other weighing device configured to weigh a shopping cart and its contents,
a plurality of store products, each tagged with an RFID tag having a unique identifier,
a database in which each unique identifier is associated with the weight of the associated product,
one or more RFID reader(s) configured to read all RFID tags present in a single shopping cart,
a database in which the price of each product is associated with its unique identifier, and
a computer or other processor configured to correlate the combined weight of a particular shopping cart and its contents, as measured by the scale or weighing device, with the expected combined weight of the shopping cart and all products detected in the step of reading the RFID tags present in the shopping cart, and to output an event notification in the event of a discrepancy between the actual and expected weights which exceeds a pre-set threshold.

The system as described is expected to output an event notification which will prompt a review of the shopping cart contents to determine the presence or absence of several conditions which are significant to a business, to a customer, or to both, including but not limited to item(s) missing from a product package, extra item(s) present in a product package, unexpected item(s) present in a product package, item(s) present in the shopping basket but lacking an RFID tag, preventing multiple scans, and associated charges, of the same item, and so forth, serving quality assurance and security functions.

In addition, the system as described can optionally function in a non-fully automated mode, in which “live” customer service would be provided for those item(s) which do not have RFID tag or for which the product read scan did not detect all items, and thus trigger an event notification for “unexpected item(s) in basket.”

Further, the system as described optionally can provide event notification for products present in the shopping cart which are expired, recalled, damaged, or otherwise not suitable for sale.

It is expected that the system as described will initially be most cost effective for those stores selling higher cost items such as electronics, appliances, tools, kitchen and bath items, toys, and the like. Exemplary national retail chains which would be expected to benefit most easily from use of the inventive systems include Best Buy, Home Depot, Toys-R-Us, and Linens-n-Things. It is further expected that if the cost of RFID tags continues to decrease, more businesses can benefit from the speed, convenience, and accuracy of the inventive systems.

### Example 3

### Improved Service Call Efficiency

Service vehicles which carry assets/inventory may require specific test kits, tools or other hardware/components in order to complete a task. By having tracking, for example RFID tags, on individual items, the technician is able to cross reference the job with the tools and other components to evaluate if anything is not on the vehicle prior to dispatch. This reduces errors and labor because it prevents the technician from making multiple trips to a destination because of lack of tools or other components to complete a job.

### Example 4

### Improved Item Ordering Efficiency

A benefit of having tracking, for example RFID tags, on items either labeled as assets or inventory on a vehicle is that technicians may require a specific item while on the job or task. In this case they would key in the item they are searching for and be able to locate another vehicle within proximity of their vehicle by using a GPS device which updates inventory/asset information to a database which is accessible by the technician.

In this example, a technician can avoid calling or messaging multiple technicians to locate the item they require to finish a job, etc. By having a GPS interface with the inventory/asset tracking software, Applicant's inventive subject matter can help reduce the amount of time wasted searching for specific items. This also will help companies with reducing the amount of assets they keep in stock because items such as test kits for telecommunications companies, for example, can run as much as $80,000.00 each. By having a real-time asset locator, companies can transfer assets to desired locations upon request and track the location of where the item was last used and by whom.

### Example 5

### Improved Asset Accounting

By providing a GPS interface, the inventory or asset item being tracked, for example using RFID, would have other benefits such as assignment of an asset such as a converter cable box that is installed at a customer site by a cable technician or a modem that is installed by a telecommunications carrier. As the item is removed from the company vehicle, it is assigned to the designated address using GPS, which can permit cross referencing the account with billing records. Thus, in the event an asset/inventory item is being installed at a duplex, apartment complex, or office building, it would require an input of the apartment number, suite or other identifier because the software would recognize that the GPS location, when cross referenced with the billing records, has more than one location in the database.

Such an assignment task doesn't require the technician to input any data if the item is being installed at a single family residence, single business, etc. This cross reference feature can work in conjunction with the embodiment in Example 1 above, because it would also evaluate whether the items on the vehicle are sufficient for the job assignment. This feature, with a date/time stamp, also provides an audit trail as to when an asset was delivered or installed for a specific job.

### Example 6

### Improved Asset Handling and Environmental Conditions Tracking

RFID tags now have the ability to measure parameters such as “shock” or “temperature,” which has several benefits when applied to assets or inventory. In one example, in the food or pharmaceutical industry, the application provides the ability to measure temperature as the product(s) are being transported to the desired designation. A recording of the temperature is uploaded to a database(s) that evaluates whether or not an item has reached a pre-determined temperature that affects the product quality, or more importantly effectiveness.

Similarly, in another example, in the cable industry, equipment that supports fiber optics is often sensitive, and a “shock” measurement would provide an “event” notification to a specified party when an asset or inventory item has experienced a maximum “shock” recording that could have been detrimental to the item. Another example of the benefit of the “shock” measurement would be when an asset has been tampered with by someone, or come into contact with something. Such a tracking system, for example using RFID tags, would upload the recording to a database(s) which would evaluate said recording data to determine if an item has been tampered with or reach a “shock” measurement that requires attention.

### Example 7

### Improved Theft Detection and Prevention

Another benefit of a tracking system, such as an RFID application, for asset or inventory tracking is beneficial for enterprises whose consumers may be using enterprise assets without permission. Currently, for example, cable operators use a method known in the industry as “pinging” to determine if a residence or business is obtaining cable from the cable operator without payment or otherwise illegally. This is cross-referenced with billing records, and then procedures are taken to prosecute the individual(s).

By placing an “active” RFID tag on an asset, the asset can be identified from the exterior of a building, whether residence or business. As service technicians routinely service certain areas, an RFID reader could be configured to read active tags while on a route, and to cross reference the tag identifier with a GPS interface, thus providing a report for the collections/billing department. Within the system, the report as to residences or businesses that have an asset of the cable operator and do not have a billing record in the system could be flagged, thus reducing the time currently allocated by engineers to locate those individuals committing a felony and misappropriating enterprise assets.

### Example 8

### Improved Loss Prevention

Another benefit of having the an asset tracking system, such as RFID tags, on an inventory/asset item is the ability to trace specific items that are not assignable to a customer or job site. For example, in the telecommunications industry, a test kit which has a considerable value may be removed from a technician's vehicle. If the item is not on the vehicle once the vehicle is again in motion, which may be determined using GPS, then an alert or other message or communication is sent to prevent loss of the item, in effect informing the technician that a particular asset item is not located. This would prevent the loss of the item and time allocated searching for the item.

### Example 9

### Improved Vehicle Rental System

Vehicle rental companies using the inventive RFID asset tracking system will be enabled to make renting vehicles faster and more convenient. For this purpose, RFID enabled frequent user cards are used to speed the car rental process and to provide a more seamless travel experience for customers.

The asset management system enables a customer to walk up to a vehicle, accept the rental terms, and drive away without any human assistance, accomplished by placing the RFID-enabled membership card within reading range of an RFID interrogator antenna mounted on or near the vehicle. On verification of the customer participation, an onboard computer unlocks the vehicle's doors. Before driving away with the car a computer attached to the vehicle requires the driver to produce a valid license, and in the event one is provided, an immobilizing device is released, allowing the vehicle to be operated.

### Example 10

### Improved Parking Facility Operations

Parking facility operators have significant labor costs and cash reconciliation issues. Parking customers may prefer having the convenience to park without carrying cash or credit, or facing the trouble of locating a paper parking ticket, which may become a lost ticket.

In an exemplary solution to these problems provided by the inventive subject matter, a printing device located at garage entrance prints a ticket incorporating a passive RFID tag, which the customer receives upon inserting a credit card or cash upon entry, or in which a pre-registration has taken place, for example on-line, for an automated billing process directly linked to the customer's account, which provides a credit associated with the passive tag. Account processing is tied to a database which confirms a deposited balance available on the tag, or bills a customer account which is on file. Current networks, such as EZ-Pass, may be expanded and enabled for accessing customer accounts through a central database, eliminating need for parking facility attendants.

### Example 11

### Exemplary Commercial Inventory Tracking and Management System

An exemplary application of the inventive subject matter is an inventory, tracking, and management system for commercial assets of a business enterprise. Multiple subsystems may optionally and advantageously be utilized to track different assets in different ways throughout a supply chain, for example by relying on sensor networks, global positioning systems, and auto-identification technologies to improve efficiencies and supply chain processes.

For example, GPS technology may be used for container tracking, such as to monitor shipments by truck, train, or transport ship. A GPS monitoring subsystem permits both tracking updates over time as assets are in transit, but on-demand queries to determine location at any time desired.

In addition, smart shelves can be used for storing smaller assets such as finished goods and maintenance parts. Such assets are optimally tracked using attached RFID tags. Readers in the shelf will sense when an asset has been added or removed, automatically debiting or adding inventory to a database. In some instances, hybrid solutions using passive RFID tags to monitor smaller or less expensive assets, and active RFID tags to keep track of larger or more expensive assets are optimally employed.

Further, a mesh-sensor network may be used to create a virtual warehouse for a storage site, allowing a company to monitor materials and parts based on grid location.

### Example 12

### Improved Personal Asset Inventory and Management System

An exemplary application of the inventive subject matter is an inventory, tracking, and management system for personal assets. For example, one might chose to manage a music collection, a book collection, a collection of items one wishes to list as available for purchase, or a purchase wish list.

Assets are uniquely tagged and listed in a database. For purposes of this example, asset tagging is by bar code. However, any system providing unique identifiers may be used. When assets are moved or removed from a location, a bar code reader logs the movement and the database is updated. Additional, exemplary information that may also be included for each item includes asset class or type, age, condition, price, and the like, although it would be apparent to one of ordinary skill in the asset management field that there are a great many types of information that can be associated with an asset.

Based on permissions and roles which can be assigned to users of the system, to individual assets, and/or to classes of assets, access to each item can be uniquely determined for each system user. For example, information about a certain asset, including its existence, can be kept entirely private to a single user, while other assets may be listed in public collections available to all system users. The system can be configured to provide periodic or special reports as to any or all of the parameters associated with any or all assets in the database.

Such a system will allow users to showcase personal assets and collections, contact others with similar interests, make purchases or trades, and bring more engagement with and enjoyment from personal assets.

### Example 13

### Exemplary Integrated Maintenance, Repair and Overhaul Supply Line

MRO—maintenance, repair and overhaul—is an area of government contracting that is ripe for savings and revenue opportunity. These functions are most effectively managed by a combined supply chain equation, linking maintenance strategy to supply side strategy. RFID fulfills MRO event requirements by enabling real-time track and trace, and unique asset identification. The aerospace and defense industries are expected to benefit from projects and technology that combine real-time case and pallet tracking with better spare parts and reusable asset management to serve, for example, Department of Defense needs.

An integrated MRO strategy using RFID tagging technology will streamline such tasks as locating parts, tools and materials, as well as facilitate preparation of the significant amount of documentation required to meet regulations in many industries such as aerospace and defense. An integrated MRO supply chain will improve service performance in a manufacturer's storeroom by simplifying inventory, purchasing, and other business processes, and allows the centralization of all sourcing, procurement, receiving, internal distribution, and service to one supplier selected from a plurality of potential sources. The full benefit of integrated supply is achieved when all MRO supply chain functions are outsourced, thereby allowing a plant to better focus on its core competencies.

### Example 14

### Exemplary Inventory Management Systems and Methods

It will be readily apparent to one of ordinary skill in the art that the inventive subject matter may require access to the inventory databases of multiple manufacturers, suppliers, distributors, retailers, other sellers, or a combination thereof. With appropriate permissions and roles, multiple individual company databases, shared databases, or both can be searched. In one aspect of the inventive subject matter, such multiple or shared databases are as described in Applicant's U.S. patent application Ser. No. 09/799,879, filed Mar. 7, 2001, now U.S. Pat. No. 6,998,538, issued Feb. 7, 2006, the entire contents of which is hereby incorporated by reference in its entirety, and selected sections of which are included below.

The following example illustrates a preferred inventory management system which is optionally used to create and maintain the at least one database having information relating to an inventory item, as described in detail herein.

### Background of Preferred Inventory Management

Traditionally, inventory control has been done by the company or organization using the items in the inventory. In smaller offices, inventory control is typically not a high priority, and orders may be placed whenever items are out of stock.

As an office increases in size, inventory management becomes more of a challenge, and monitoring of frequently used or crucial items becomes very important. Typically a person is given the responsibility of monitoring inventory and ordering replacements as supply diminishes. As a company further increases in size, more advanced inventory management techniques may be used. For example, supply and usage trends may be analyzed to determine minimum quantities on hand, and seasonal or other peak usage may be determined.

Some larger offices have switched to automated or semi-automated inventory tracking systems. These automated systems utilize barcode scanners or other electronic identifiers to track outgoing and incoming inventory, and can prepare purchase requests as supplies diminish.

### Summary of Preferred Inventory Management

The preferred inventory management system improves upon the prior art by shifting the burden of inventory tracking onto a third party; this concept is referred to as vendor managed inventory, or VMI. When a third party provides VMI services for multiple companies, it gains significant buying power which it can use to negotiate better deals, improve supplier responsiveness, and streamline the buying process.

The preferred inventory management system allows third-parties to monitor company inventory via the Internet and World Wide Web (“web”). In addition, the preferred inventory management system allows small to medium sized companies to take advantage of VMI by providing a cost-effective solution to their inventory tracking needs.

The preferred inventory management system utilizes web-enabled technologies to revolutionize inventory management by tracking inventory and automatically contacting suppliers, manufacturers, or distributors when additional supplies are needed. This may result in a labor reduction as compared to the labor-intensive inventory maintenance systems currently deployed.

In addition to reducing labor costs, the preferred inventory management system may help a company cut other costs. The preferred inventory management system may help reduce delivery costs by regularly ordering supplies in anticipation of need, thus obviating the need for express shipments. The preferred inventory management system may also allow third parties to take advantage of manufacturer or distributor specials when offered for the products its customers require, thus further reducing customer cost.

While purchasing is a large part of inventory maintenance, the preferred inventory management system may also facilitate other transactions as well. For example, the preferred inventory management system may allow customers to resell products or equipment to other businesses, thereby maximizing utility. Although some in the prior art, such as Neoforma.com and Medibuy.com, have attempted to provide business-to-business equipment resale through web-based auctions, auctions do not provide equipment availability assurances. The preferred inventory management system provides a forum through which resellers and customers may interact, where the preferred inventory management system acts as a broker, thereby assuring both that purchased equipment is delivered, and that a seller receives proper compensation.

### Detailed Description of the Preferred Inventory Management

The preferred inventory management system implements an Internet-based, vendor managed inventory (“VMI”) system. A VMI system allows a customer to reduce costs by pushing inventory management responsibilities onto a third party, or manager. Managers may service multiple companies, thus allowing them to negotiate better deals, improve supplier responsiveness, and serve as an effective customer advocate.

The preferred inventory management system allows managers to inexpensively monitor customer inventory via the Internet and World Wide Web (“web”). The preferred inventory management system utilizes web-enabled technologies to revolutionize inventory management by tracking inventory and automatically contacting suppliers, manufacturers, or distributors when products are needed. This may result in a labor reduction as compared to the labor-intensive inventory maintenance systems currently deployed.

FIG. 1 is a block diagram illustrating the major hardware components of the preferred inventory management system. As illustrated in FIG. 1, the preferred inventory management system utilizes a client/server architecture to facilitate communication between customer inventory systems and managers. A client running on a Customer Inventory System 130 may be used to track inventory, place special orders, and interact with other customers.

A client may include custom software, such as an application written in Visual Basic, JAVA, or C; commercial software, such as a web page accessible through a web browser; or a combination of custom and commercial software, such as a “plug-in” which operates in a web browser. Examples of common web browsers include Internet Explorer, developed by Microsoft Corporation of Redmond, Wash., and Navigator, developed by Netscape Corporation of Mountain View, Calif.

Customer Inventory Systems 130 may allow manual inventory tracking, semi-automated inventory tracking, or inventory may be dispensed using automated systems. By way of example, without intending to limit the preferred inventory management system, a preferred embodiment of the preferred inventory management system includes a handheld device, such as a Palm VII device by Palm Computing, Inc., to be outfitted with a barcode scanner. Such a device can allow barcodes or other identifiers associated with each inventory item to be scanned or otherwise entered into the system prior to or at the time of item distribution. As each item is scanned, a count maintained by the preferred inventory management system may be adjusted to properly track inventory levels. Recipient-specific labels, including product warnings and other information, can then be printed for each scanned item.

Other inventory distribution methods contemplated include, but are not limited to, interfacing the preferred inventory management system with vending machines. Vending machines may allow accurate inventory tracking without requiring human interaction, except to periodically restock a particular supply or group of supplies. In a preferred embodiment, vending machines may include security measures to prevent unauthorized supply distribution.

Such security measures may include, but are not limited to, the use of an identification card and personal identification number (“PIN”), and biometric systems. Vending machines equipped with security systems may restrict access to specific supplies on an individual-by-individual level, or group-by-group basis. Vending machines may also be equipped with label printers that allow warnings and other information to be attached to a dispensed item's packaging.

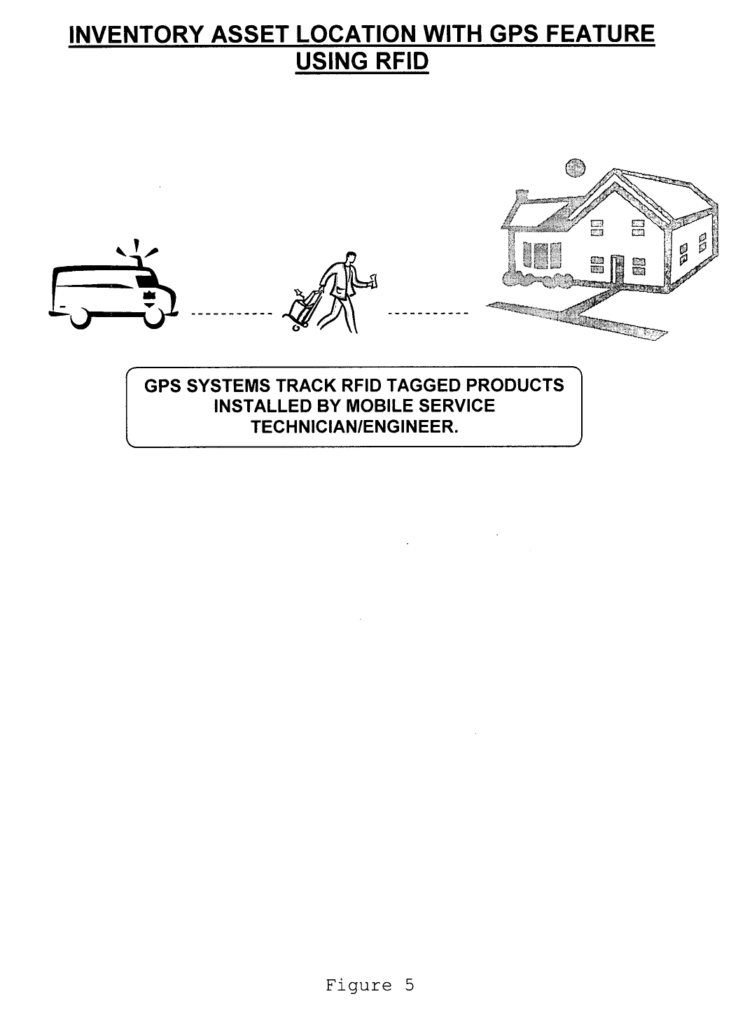

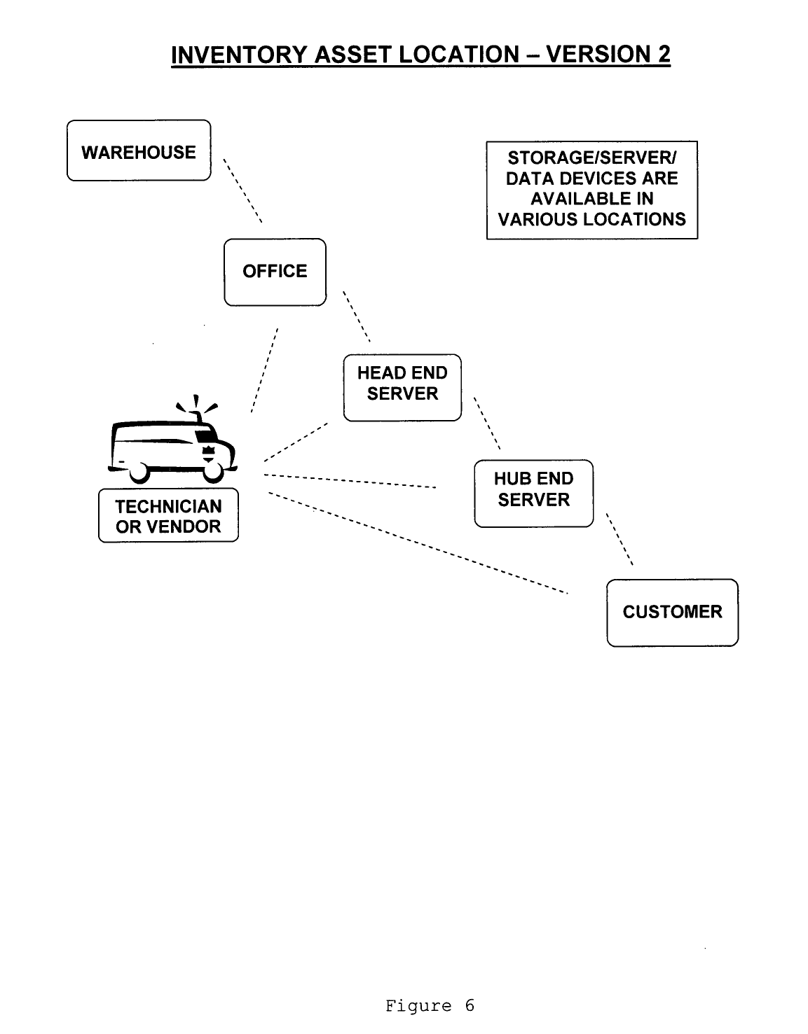

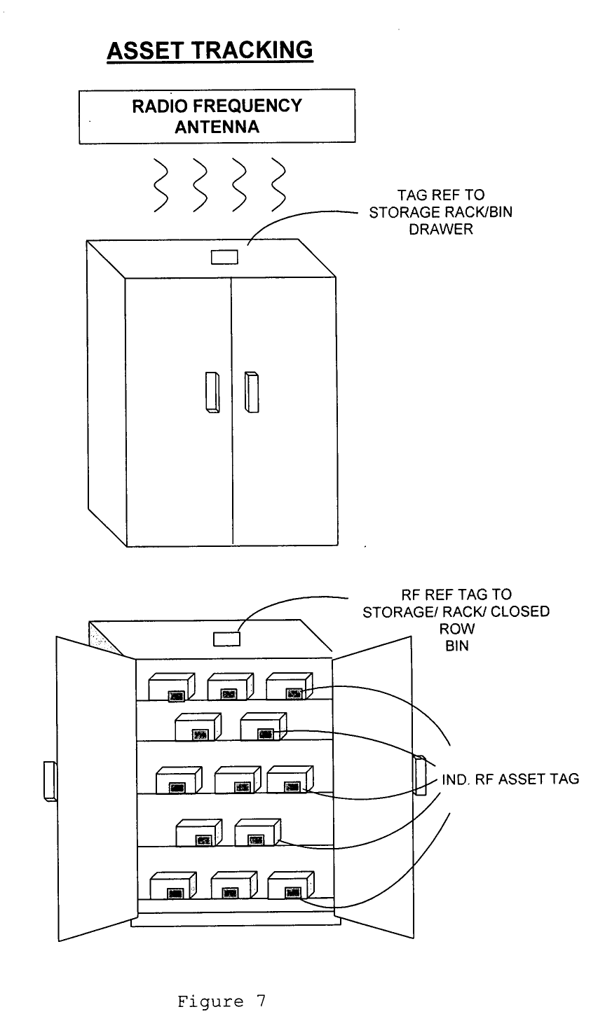

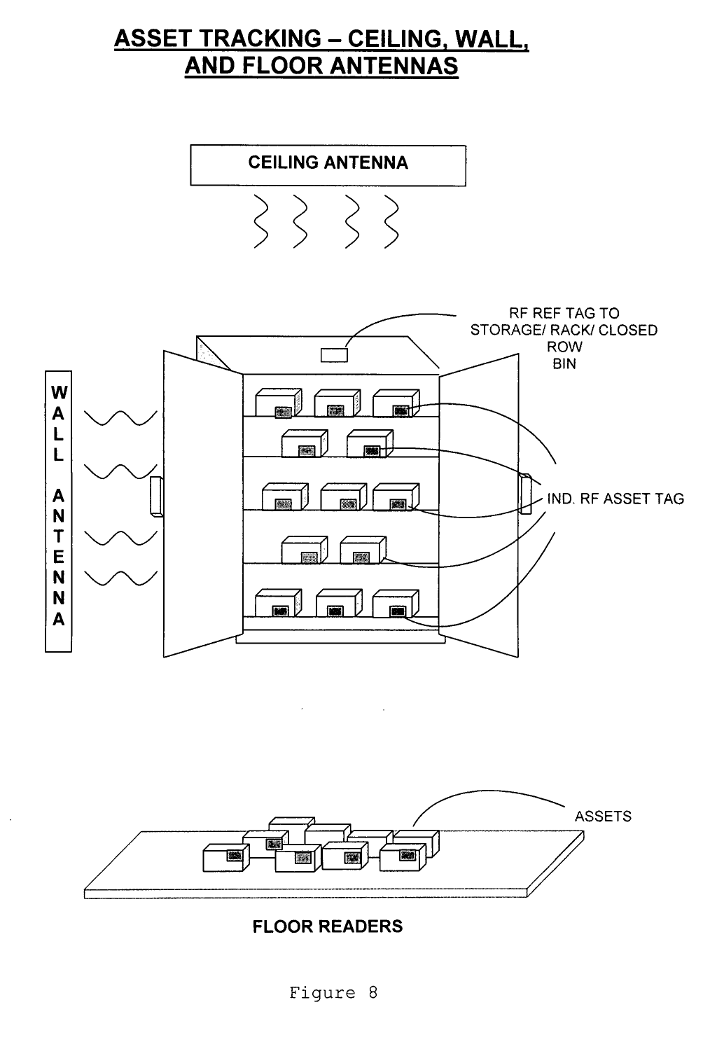

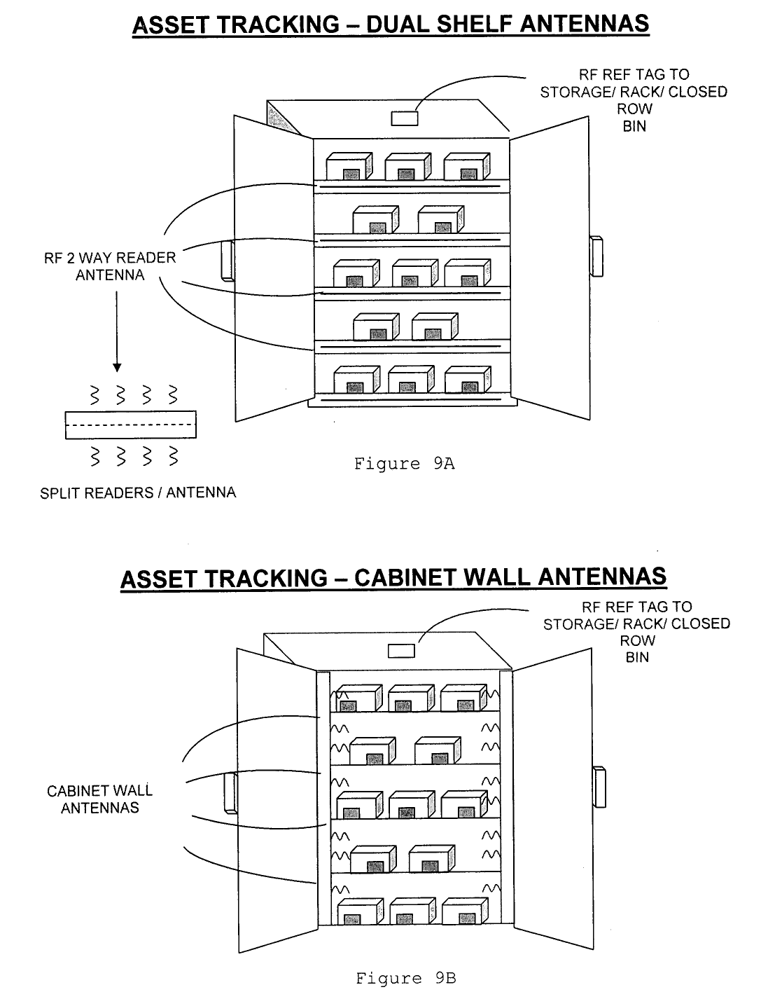

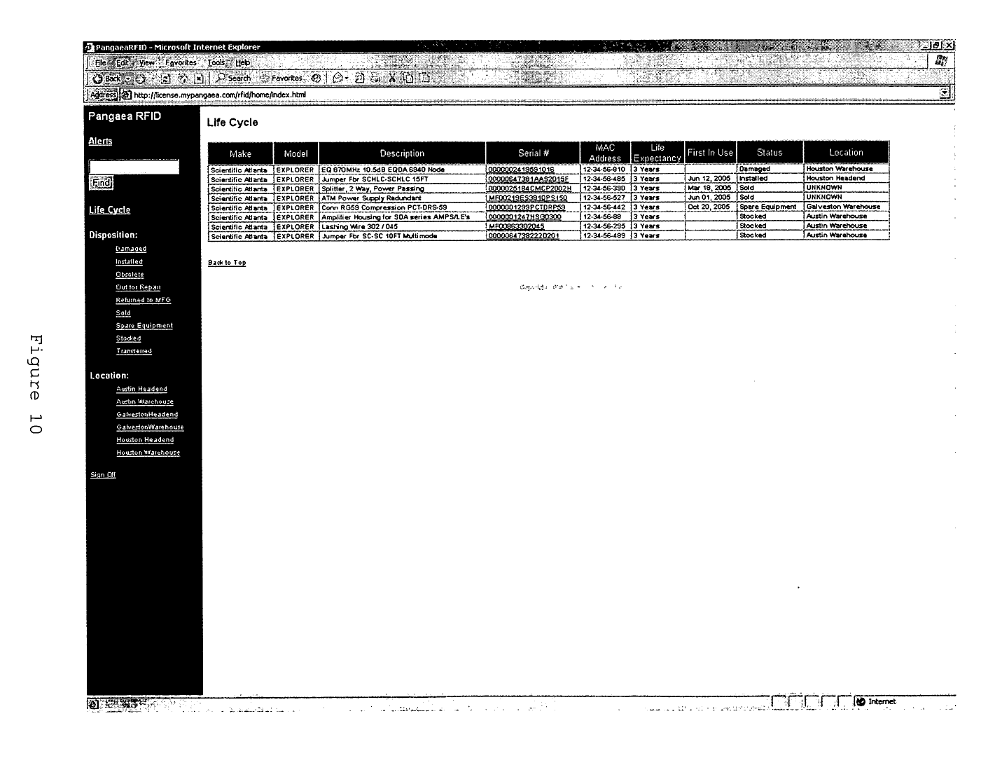

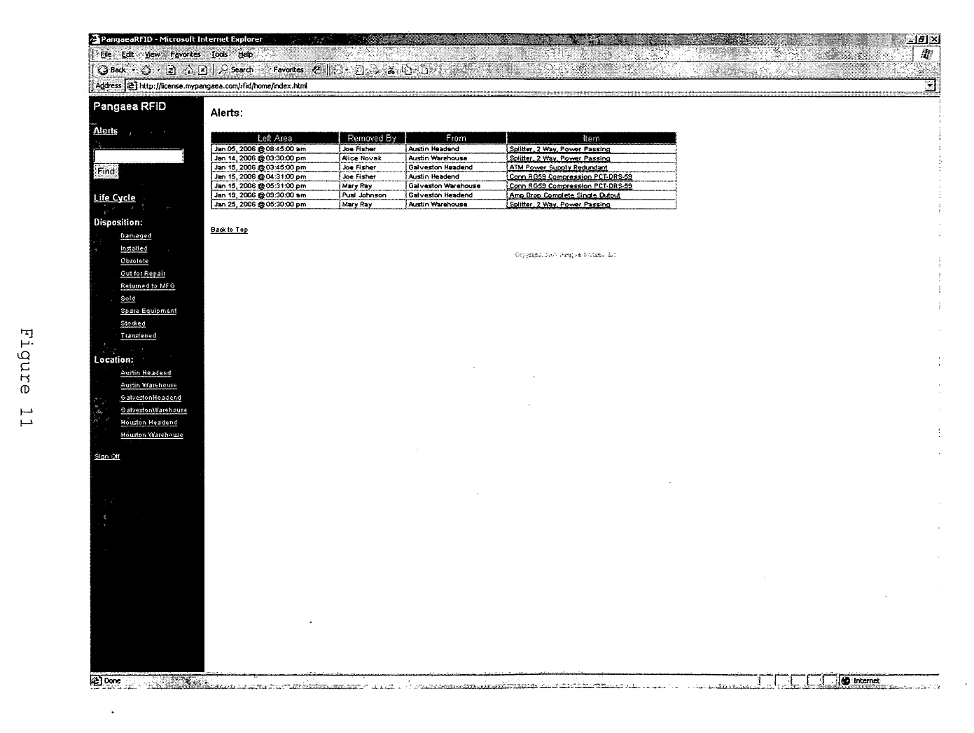

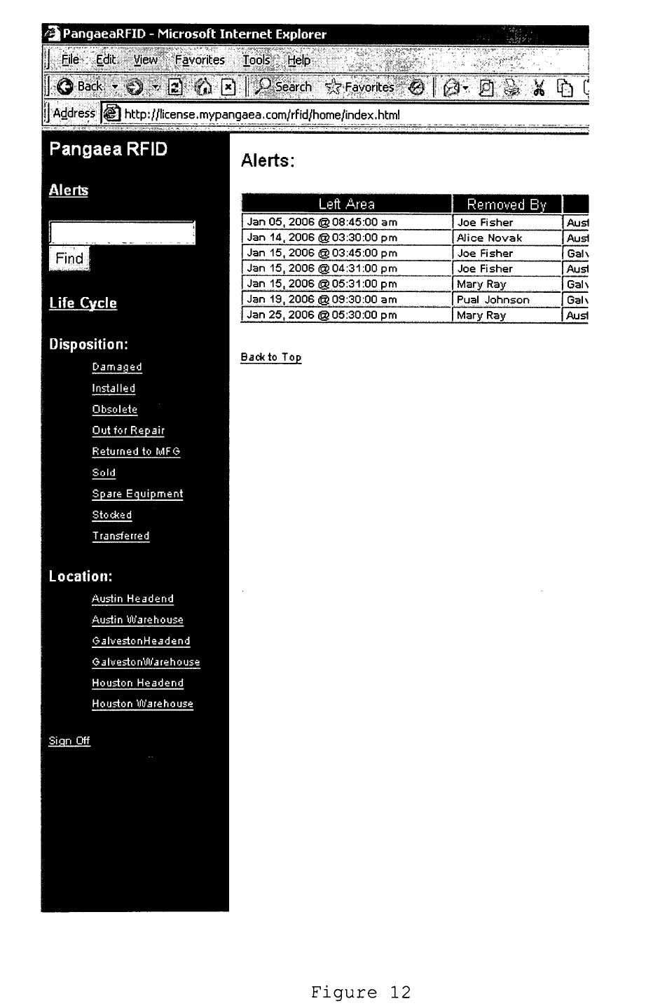

Alternatively, supply closets or other storage areas can be outfitted with a Radio Frequency Identification (RFID) portal, as illustrated in FIG. 5. An RFID portal (Block 500) is similar in structure to airport security metal detectors, except that RFID portals can detect or scan RFID tags as such tags pass through a portal. The preferred inventory management system can monitor RFID tag identifiers, including identifiers assigned to individuals, such that access to a storage area can be monitored, and items removed by an individual can be tracked without any direct user interaction.

A preferred embodiment of the preferred inventory management system can also track individual product dispensation, and may require additional information as products are dispensed. By way of example, without intending to limit the preferred inventory management system, if a doctor dispenses sample medication to a patient, the preferred inventory management system may also request a patient identifier, whereas if a package of gauze bandages was removed from inventory to restock an examination room, the preferred inventory management system may not request a patient identifier. Patient identifiers can be used by the preferred inventory management system to generate dispensation history reports for various products which may help suppliers and manufacturers to better understand income, race, ethnicity, or other demographic characteristics of typical recipients. The preferred inventory management system may restrict such reports to only demographic information, and may not include individual-specific information in such reports.

An alternative embodiment of the preferred inventory management system allows physicians or others to carry a handheld device through which prescriptions can be written while talking with a patient. Such a handheld device can connect to a local inventory management system through a wireless or wired means, and, when appropriate, a prescribed item sample may be automatically dispensed by a vending machine. Alternatively, a message may be displayed at a nurse's station indicating the items to be pulled from inventory. When items are dispensed by a vending machine or pulled from inventory, inventory counts can be decremented as appropriate, and new orders can be placed as necessary.

As inventory is distributed, Customer Inventory System 130 may track supply usage habits to determine minimum acceptable quantities on-hand. Usage information may be studied for various periods of time, and the preferred inventory management system may create an inventory usage model based on collected data. As models are created and refined, the preferred inventory management system may modify minimum in-stock thresholds to reflect anticipated usage. As quantity in-stock approaches a calculated or specified threshold, Customer Inventory System 130 may automatically request new supplies from Server 100. Supply requests may include various information, including, but not limited to, urgency of request, customer willingness to accept alternative brands or sizes, billing information, and shipping information.

As Server 100 receives supply requests, Server 100 may request price quotes from several Manufacturer, Supplier, or Distributor 120's (“Distributor 120”). Distributor 120 may respond with quantity available, price, estimated delivery time, and other such information. Server 100 may then automatically evaluate each Distributor 120 response to find the best value given various factors associated with each customer request. When an appropriate Distributor 120 response is chosen, Server 100 may automatically arrange payment and shipping of requested supplies for Customer Inventory System 130.

Communication between Customer Inventory System 130, Server 100, and Distributor 120 may be achieved through various methods, including, but not limited to, hypertext transfer protocol (“HTTP”), file transfer protocol (“FTP”), simple mail transfer protocol (“SMTP”), or other such related methods.

Although purchasing is a large part of inventory maintenance, a preferred embodiment of the preferred inventory management system may also facilitate communication between customers, provide a source of information dissemination, and encourage customer interaction. The preferred inventory management system may facilitate customer communication by allowing customers to resell products, equipment, or excess inventory to other businesses. The preferred inventory management system may allow information dissemination by providing an up to date catalog of available equipment and other inventory from which a customer may order. The preferred inventory management system may facilitate customer communication by allowing managers and customers to author and distribute articles describing new rules, regulations, procedures, revenue generation prospects, or other information of interest to other customers.

Customer Inventory System 130 may serve as the primary source of customer interaction with the preferred inventory management system. Articles, catalogs, inventory information, and other such information may be stored on Server 100, and Customer Inventory System 130 may communicate with Server 100 to obtain requested information.

FIG. 2 illustrates a preferred embodiment of Server 100, in which relationships between data storage, web server, and application services provided by Server 100 are illustrated. All client communications may first pass through Firewall 210. Firewall 210 represents a combination of software and hardware which is used to protect the data stored in Web Server 220, Database Server 230, and Application Server 240 from unauthorized access.

As previously described, clients may communicate with the preferred inventory management system through various protocols, including HTTP. Web Server 220 represents software capable of transmitting and receiving information via HTTP or other protocols. Examples of such software include Internet Information Server, developed by Microsoft Corporation of Redmond, Wash.; Enterprise Server, developed by Netscape Corporation of Mountain View, Calif.; and Apache Server, developed by the Apache Software Foundation of Forest Hill, Md.

When a client requests information, Web Server 220 may determine whether a client request requires pre-processing, in which case a request is transferred to Application Server 240, or if a request simply requires data to fulfill the request, in which case Web Server 220 may communicate directly with Database Server 230.

Database Server 230 represents commercially available database software, such as Microsoft SQL Server, developed by Microsoft Corporation of Redmond, Wash., Oracle 81, developed by Oracle Corporation, of Redwood Shores, Calif., or other, similar software. Database Server 230 may store raw data, such as customer inventory information, customer addresses, vendor names, vendor product classes, and other such similar information. Such information may be transmitted to a client by Web Server 220, or Application Server 240 may interpret information stored in Database Server 230 prior to transmission.

Application Server 240 may contain business rules associated with the present invention, which can be used to interpret Database Server 230 data prior to transmission of that data to a client. In addition to interpreting information stored in Database Server 230 for client use, Application Server 240 may also monitor inventory levels reflected in Database Server 230, contact vendors based on information from Database Server 230, adjust inventory information as new inventory is received, and provide the services necessary to facilitate business-to-business resale of equipment or products stored in Database Server 230.

Web Server 220, Database Server 230, and Application Server 240 each represent software which may run on the same computer, or on multiple computers. In addition, Application Server 240 may be implemented within Database Server 230 as a set of business rules.

An alternative description of the preferred inventory management system follows, in which the preferred inventory management system is described through a series of functional specifications. This information is included for enablement purposes, and describes the best mode contemplated at the time the present specification was filed. While the following functional specification describes a preferred embodiment of the preferred inventory management system, descriptions within the functional specification should not be construed as limiting the preferred inventory management system.

To avoid confusion, the following terms are used in this functional specification:

Customer—Refers to a buyer of products via the preferred inventory management system. Customers can have “open account” relationships to avoid credit card and COD shipment problems.

Linked Supplier—A distinction is made to avoid confusion with other vendors doing business with the preferred inventory management system, given that payables may be in a common accounts payable system. Distributors, manufacturers, or other vendors (collectively “suppliers”), are distinguished by whether they are using the preferred inventory management system's inventory tracking and accounting software, and therefore have live Internet linkages into their databases for queries, order processing, and billing.

Manual Supplier—If a supplier provides goods or services through the preferred inventory management system, but tracks inventory through a manual interface, such a supplier may be termed a “Manual Supplier”. Open account relationships may be maintained between Linked or Manual Suppliers avoid payment complexities.

Non-linked Supplier—Suppliers not linked to the preferred inventory management system.

Products—Items for sale via the preferred inventory management system.

Customer Inventory—A list of products to be maintained at a given customer site.

In addition to the general definitions set forth above, this functions specification also defines a set of system functions. System functions may fall into one of the following general sub-system categories:

Interactive—human interface and related functions for tracking inventory counts, inventory consumption rates, ordering critical products, and the like. Interactive processes may be web-based or PC-based (client-server).

Nightly Processes—periodic processes through which orders can be generated and invoicing and related processes can be performed, including interaction with Distribution system at distributor warehouses.

Corporate—processes performed within corporate offices, but which update a database. Includes accounting, client data management, and other such processes.

Distribution—Linked Suppliers integrated with the preferred inventory management system. Industry standard Enterprise Resource Planning (ERP) software may be bundled with commercial financial software to provide a complete business system to Linked Suppliers.

Database Design—A database schema which may be utilized in a preferred embodiment of the preferred inventory management system.

The preferred inventory management system in general, and this functional specification specifically, defines styles and functions included in detailed web pages and other user interface elements that are intended to be available system wide. Web pages, application windows, program screens, and transactions within the preferred inventory management system should observe common rules. These rules include, but are not limited to:
No customer can view, inquiry into, update or in any way alter another customers data. Transactions can use an IP address or other unique identifier as a cross-check against a customer ID coming in with transmitted pages to insure rule enforcement. For such security procedures, customer IP addresses or other unique identifiers may only be changed through a function accessible only to Corporate staff.
No Linked Supplier can see data belonging to another linked supplier.
System parameters controlling customer options can be set through an account setup and editing process. Such a process may be accessed by only someone with an authorized identifier. Initially, such identifiers may only be given to Corporate Staff.
Data changes will generally be reflected by a transaction log or transaction history, which may be accessible to customers or distributors, and to which Corporate Staff with appropriate security levels may have access.

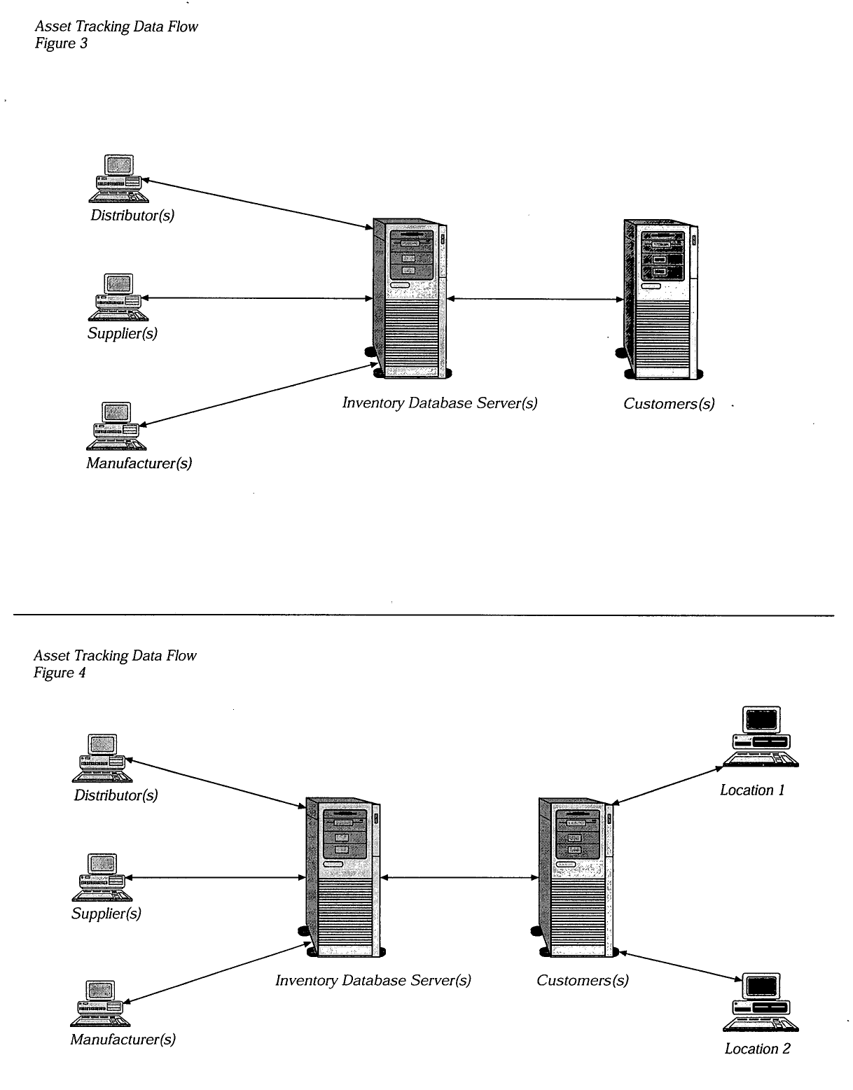

Functions involving data changes may be performed as server-side scripts, rather than through client-side logic. In general, such server-side scripts can utilize a logical flow similar to FIG. 3. As FIG. 3 illustrates, client software running on a customer machine may generate a page containing data to be updated by a web server and transmit said page to said web server (Block 300).

When a web server receives a page from a customer machine, the preferred inventory management system may attempt to process any changes requested by said page. If such changes are successful (Block 320), the preferred inventory management system may return a confirmation page or cause a confirmation message to be displayed to a customer machine, and appropriate transaction logging may occur.

If changes are not successful, the preferred inventory management system may increment a retry count by one (Block 340). If the retry count is less than or equal to three, the preferred inventory management system may retransmit customer changes (Block 370) to Block 310 in an effort to make any appropriate changes. If the retry count exceeds three (Block 350), the preferred inventory management system may cause a page containing any error codes or other feedback information to be displayed on a client machine. Such a page may also contain original client data changes as well as a means for resubmitting said changes (Block 360).

Client software may also periodically verify that a data connection exists between said client software and a server acting as part of the preferred inventory management system. Such software may follow the logic illustrated in FIG. 4 to achieve accurate data connection monitoring. As Block 400 illustrates, client software may send one or more TCP/IP Ping commands or other network test commands to verify that a high-speed connection is still available to a server acting as part of the preferred inventory management system.

If a high-speed network connection is detected, the preferred inventory management system can continue normal operations (Block 410). If a high-speed network connection is not detected, the preferred inventory management system may attempt to reestablish such a connection (Block 420). If a high speed network connection can be reestablished (Block 430), the preferred inventory management system may continue normal operations (Block 410). If a high-speed network connection cannot be established, a lower speed network connection, such as a dial-up network connection, may be established by the preferred inventory management system (Block 440). If a lower speed network connection can be established, the preferred inventory management system may continue normal operations, including periodically attempting to reestablish a high-speed network connection (Block 410).

If a lower speed network connection cannot be established, client software may display an application or page with alternative user interface and alternative functionality (Block 460). Such alternative functionality can include local storage of product usage information, local inventory tracking, and limited reordering via a dial-up or other temporary connection with a known supplier (Block 470). A client functioning without a data connection may periodically attempt to reestablish high or low speed network connections (Block 480). When a connection is reestablished (Block 490), a client may transmit product usage scan information to a server acting as part of the preferred inventory management system.

In addition to an inventory tracking application, the preferred inventory management system may also utilize a high speed network connection to transmit new product offerings or special promotions to a client for display to a customer. As new products are entered into a Products table or similar data structure, the preferred inventory management system may cause such a product to appear on a client. In a preferred embodiment, the preferred inventory management system may allow customers to select products in which a customer is interested, and the preferred inventory management system may only display new products or special deals meeting a customer's prior specifications. Such specifications can include, but are not limited to, categories by manufacturer, product trade name, specific product type, general product classification, and quantity available or quantity per shipping unit.

A client displaying such information may allow a customer to indicate an interest in a product by typing a command, clicking a button or other graphical interface element, or otherwise interacting with said client. If a customer expresses an interest in a featured product, a client may allow a customer to create a one-time order, or to configure recurring orders.

In addition to allowing customers to record product usage and order new inventory or new products, client software may also display advertisements on a rotating basis, and may be used for other purposes. A typical client software screen may also contain additional information and fields, including, but not limited to, a Product SKU field, a User-ID field, a Doctor-ID field, and a Sales Consultant Contact field.

When customers are not directly interacting with client software, client software may place a cursor in a Product SKU field by default. Placing a cursor in a Product SKU field can allow client software to ready accept an automatically or manually entered product identifier, such as a barcode label scanned via a wedge-style bar-code scanner.

As product identifiers are entered, client software may request a User-ID for each product identifier or set of product identifiers. A User-ID is a unique identifier created for each employee or set of employees within an organization. Such identifiers may be entered manually through an active user interface, such as, but not limited to, a keyboard, touch screen, or number pad, or through a passive user interface, such as, but not limited to, biometric recognition equipment, barcode identifiers worn by or associated with an employee, or through RFID tags worn by or associated with an employee. User-ID's may be combined with passwords to create a more secure inventory tracking system.

User-ID's may be used to track persons removing items from an inventory, but additional tracking or other controls may also be desirable. For example additional authorization may be required when employees remove expensive items or controlled substances from an inventory. The preferred inventory management system may recognize when such an inventory item is removed, and client software may request an additional identifier, called a Doctor-ID, as authorization. Client software may even allow any user to enter a Doctor-ID for some inventory items, while for other inventory items a Doctor-ID and related password may be required. A biometric or other positive identifier may be used in place of a Doctor-ID or Doctor-ID and password in some applications.

When appropriate inventory tracking data has been entered into client software, the preferred inventory management system may transmit such data to a server. A server may send a confirmation message to a client upon receipt of such data. If a confirmation message is not received within a predetermined period of time, the preferred inventory management system may resend inventory tracking data. If successive resend attempts are unsuccessful, the preferred inventory management system may follow a process similar to that illustrated by FIG. 3. Client software may allow additional inventory scans to occur while waiting for confirmation from a server.

In addition to recording inventory tracking information, client software may also allow a customer to access various options. Such options may include, but are not limited to, an administrative page, an inventory status inquiry page, and an inventory receipt page. An administrative page can allow authorized customers to create, edit, or remove User-ID's, Doctor-ID's, groups of such accounts, and account-specific information. An inventory status inquiry page can retrieve and display a page containing customer inventory records, order status, and other such information.

An inventory status inquiry may be initiated through client software, which can send a page containing customer-specific information, as well as site-specific identification information stored on a client machine. In a preferred embodiment, a server receiving such a request may select records with appropriate site- and user-specific information from a table of customer inventory records. A server may generate a page or screen containing customer inventory information, including information from several tables. Table 1 below provides an example of columns displayed on a typical inventory request screen, as well as sample table and field names from which such data can be drawn.

TABLE 1

| Column | Source | |
|---|---|---|
| Heading | Table | Source Field |
| Description | PRODUCTS | DESCRIPTION |
| Product | CUSTOMER_INVENTORY | PRODUCT |
| Quantity In Stock | CUSTOMER_INVENTORY | ON_HAND_QTY |
| Order Point | CUSTOMER_INVENTORY | ROP |
| ReOrder Quantity | CUSTOMER_INVENTORY | ROQ |
| Activity Status | CUSTOMER_INVENTORY | STATUS |

An advantage of the preferred inventory management system over the prior art is the ability to simplify adding new items or restocking items into an inventory. Linked Suppliers shipping goods to a customer can provide a specially coded packing list, and a customer can automatically or manually enter such a code into client software. Client software can validate a packing list number as belonging to a customer and ensure a packing list is not credited to a customer system more than once. Entry of an invalid or previously validated packing slip can cause client software to display an error message.

If a valid packing slip is entered, client software may retrieve shipment contents from a centralized database or from a supplier database, and automatically update customer inventory information to reflect inventory received. Client software may then display a message confirming successful inventory changes, and return a customer to a main page.

A product search page may also be accessible through client software. A product search page can allow a user to select a search type and, if appropriate, search parameters and search parameter values (collectively “search criteria”). By way of example, without intending to limit the preferred inventory management system, a product search page may allow a customer to search by specific manufacturer and products of a certain classification.

When a customer has selected appropriate search criteria, client software may pass such search criteria to a server. A server may query a database of products and product descriptions and return products matching or approximating customer search criteria.

If a user has selected a descriptive search, a server may select records from a Products table, or other similar table, whose data matches or approximates descriptive text entered by a user. If a user has selected a parameter search, a server may select Product table records whose fields match or approximate user search requests. To expedite such selections, a server may index descriptions, manufacturers, product classes, product names, and other frequently searched fields.

When appropriate records are selected, a server may transmit such records to client software for display. Client software may present such records in a variety of formats, including, but not limited to, a columnar or tabular format. Table 2 lists sample column names, sample source table names, source field names, and additional functionality client software may present when displaying such records.

TABLE 2

| Column | Source | |
|---|---|---|
| Heading | Table | Source Field |
| Description | PRODUCTS | SHORT_DESCRIPTION |
| Product ID | PRODUCTS | PRODUCT_ID |
| Manufacturer | PRODUCTS | MANUFACTURER |
| Mfg Item No. | PRODUCTS | MANUFACTURER_ITEM_NUMBER |
| Prod. Type | PRODUCTS | PRODUCT_TYPE |
| Prod. Class | PRODUC- | PRODUCT_CLASS |
| | TIONS | |
| Check | None | Window action field |
| Availability | | |
| Add to | None | Window action field |
| Stock Plan | | |

As Table 2 indicates, client software can allow a customer to check product availability and add products to a stock plan. In a preferred embodiment, client software may make such functionality available for each record displayed. In an alternative embodiment, records may have check boxes or other selection controls, thereby allowing customers to check the availability of multiple items, and add multiple items to a stock plan.

When a customer checks availability of a product or products, the preferred inventory management system may search Linked Supplier inventories to determine quantities available, physical location, anticipated delivery times, and the like. When inventory is available, client software may allow a customer to order a product.

When a customer chooses to add a product to an inventory or stocking plan, client software may request restocking and other parameters from a customer, then send appropriate information to a server. A server may add an appropriate entry to a Customer Inventory or other similar table, thereby enabling inventory tracking through the preferred inventory management system.

Client software can also allow a customer to request a telephone call, an E-mail, or other contact from a sales consultant. In a preferred embodiment, a customer may select a product or supplier, and client software can query a server to determine an appropriate sales consultant for the selected product or supplier. A user can then be presented with a dialog box or other interactive interface which asks a customer to confirm a contact request. Once a contact request has been confirmed, client software may cause a server to store a request message in a Contact_Log table or other similar table.

In a preferred embodiment, a server may periodically scan Contact_Log table entries. When new or unanswered requests are found, a server may send a notification to a supplier alerting said supplier of such a request, where such a notification can include a customer E-mail address, telephone number, fax number, or other contact information, as well as other relevant customer and product information.

While the preferred inventory management system can monitor inventory use and automatically order new inventory when necessary, a customer may anticipate a need for additional inventory based on parameters outside the scope of the preferred inventory management system. By way of example, without intending to limit the preferred inventory management system, if the preferred inventory management system is used in a hospital, and the Olympics was held in or near the city in which the hospital is located, a hospital administrator may foresee the need to order additional quantities of frequently used supplies. Client software can provide a customer with the ability to quickly place such orders.

Customers can initiate such an order by clicking a button or otherwise interacting with a graphical or physical interface. In a preferred embodiment, a customer may select from products or groups of products already included in an inventory or stocking plan, or a customer may search for products through an interface similar to that described earlier. As previously described, customers can designate standard restocking quantities, and client software may use such quantities as defaults when clients are requesting additional inventory. Client software may also present quantities on hand to help customers make smarter purchasing decisions. Based on such information, customers can modify order quantities before submitting an order.

Client software can transmit customer orders to a server. Upon receipt of a customer order, a server can initiate an order fulfillment process.

A server may also automatically place an order based on customer demand. A server may periodically scan a customer inventory table and monitor inventory usage. As inventory is depleted, a server can predict frequently used items, and order appropriate quantities. Initially, a server may order limited quantities, to limit customer costs. A server may increase order quantities for frequently ordered products as customer usage habits dictate. A server may also construct an historical usage characterization, so that seasonal or other periodic usage patterns can be automatically taken into account.

As orders are placed, a server can query Linked Supplier inventories to determine each supplier's ability to fulfill an order. A server can calculate shipping costs as each order is processed, and a server can select one or more suppliers who can most cost effectively meet customer needs. As qualified suppliers are identified, orders are placed which can include expedited delivery and other options as specified by a customer or as determined by a server.

A server can also post supplier invoices to an accounts payable system, generate customer invoices based on supplier invoices, post customer invoices to an accounts receivable system. A server may further integrate with an automated payment system, thereby limiting invoicing and other such expenses.

In addition to customer and order related functions, a server can also provide administrative functions. By way of example, without intending to limit the preferred inventory management system, a user who is not a customer can register to be a customer through a server-provided interface. Such an interface may allow a user to specify a business name, business type, executive director or general manager, physical address, mailing address, shipping address, one or more telephone numbers, employee names, employee licensing and accreditation information, and the like.

As users submit such information, a server may validate that an address, telephone number, and zip code are all valid with respect to each other, and that all necessary fields have been filled. If any validations fail, a server may present a data entry page along with any invalid data, thus simplifying data correction.

A server and client software may also allow customers and suppliers to change various information. By way of example, without intending to limit the preferred inventory management system, suppliers can change pricing; add or remove vendors and products; add, edit, or remove contacts; view account status and open invoices; and perform other such functions. Customers can adjust inventory counts to reflect audit results; add, edit, or remove employees and employee information; update payment and contact information; view account balances and make payments; and perform other such functions.

Linked Suppliers can also take advantage of many of these same features. Linked Suppliers implementing the preferred inventory management system can track inventory; provide real-time inventory information to prospective customers; accept electronic orders; generate pick/pack lists; track order fulfillment process, including tracking into which containers each item in an order has been placed; generate bar-coded packing lists and shipping labels for each container; and generate invoices.

The preferred inventory management system also provides Linked Suppliers with other advantages over the prior art. By way of example, without intending to limit the preferred inventory management system, Linked Supplier inventory needs can be forecast based on prior order history, prior lead times, safety stock quantities, and the like, thereby reducing overall inventory investment. The preferred inventory management system can also allow enable a Linked Supplier to track processing and shipping status for various products within an order, thereby providing a higher level of customer service. The preferred inventory management system may also allow managers or other authorized individuals to electronically sign a purchase order, invoice, or other billing or order document and electronically transmit such a document to an appropriate recipient.

To achieve the functionality set forth above, a preferred embodiment of the preferred inventory management system includes the following table structure. The table structure described below is included for enablement and best mode purposes, and should not be construed as limiting the preferred inventory management system.

Table Name—

CLIENT CONTROL

Table Description and function—This table can reside locally on a customer computer. It can store one or more records containing control data needed to manage on and off-line functions remotely. These records can be updated via an update applet transferring data from the Web Server's SQL database to this control. Its purpose is to provide control over the processes running on the local machine even if it is off-line, and to enable it to reconnect automatically.

| Column (field) Name | Description |
|---|---|
| CUSTOMER_ID | Customer ID - matches Customer |
| | ID in CUSTOMERS data in the |
| | Web Server SQL Database |
| IP_ADDRESS | This is the IP address for |
| | this machine |
| DSL_PORT | Connection path or port |
| | (e.g., COM2) where DSL |
| | connection exists; |
| | null if there is no DSL |
| | line for this machine |
| DIAL_PORT | Connection path ro port |
| | (e.g., COM3) where dial- |
| | up connection exists; null |
| | if there is no dial-up |
| | connection for this machine |
| DIAL_CONNECTION_PHONE | Phone number the software |
| | dials to establish a dial- |
| | up connection to the Web |
| | server system. Null if |
| | there is no dial-up |
| | connection |
| DIAL_CALL_BACK | Phone number of the dial-up |
| | line; to allow call-back |
| | from the web server. |

Table Name —

CLIENT ERROR_LOG

Table Description and function—This table contains an error generation history for processes originating on a customer machine. It can provide an audit trail and view of how well processes are functioning, and a place to record both fatal-error conditions and those that may not need to be displayed to customers. Its data may not be processed, but can be stored for review by system administrators and managers.

| | | Field |
|---|---|---|
| Column | | Characteristics |
| (field) Name | Description | & Indexing |
| ERROR_DATE | Date of error log entry | Index - |
| | | concatenated with |
| | | ERROR_TIME |
| ERROR_TIME | Time of error log entry | Index - with |
| | | ERROR_DATE |
| CALLER | Program name generating | |
| | the error log entry | |
| ERROR_MESSAGE | Error message generated by | |
| | the caller program | |
| USER_VIEWABLE | Yes - if message also | |
| | displayed on user seen | |
| | page; No if internal only | |
| | message | |
| DATA_DUMP | Data (if any) causing the | |
| | error | |

Table Name—

SYSTEM_ERROR_LOG

Table Description and function—This table can contain a history of errors generated by processes originating from outside a customer machine. The table can provide an audit trail and view of how well processes are functioning, and provide a place to record both fatal and non-fatal errors. Such data can allow system administrators, programmers, and managers to monitor automated, unattended processes. SYSTEM_ERROR_LOG can use a data dictionary/field structure similar to a Client_Error_Log table.

| | | Field |
|---|---|---|
| Column | | Characteristics |
| (field) Name | Description | & Indexing |
| ERROR_DATE | Date of error log entry | Index - |
| | | concatenated with |
| | | ERROR_TIME |
| ERROR_TIME | Time of error log entry | Index - with |
| | | ERROR_DATE |
| CALLER | Program name generating | |
| | the error log entry | |
| ERROR_MESSAGE | Error message generated | |
| | by the caller program | |
| USER_VIEWABLE | Yes - if message also | |
| | displayed on user seen | |
| | page; No if internal | |
| | only message | |
| DATA_DUMP | Data (if any) causing | |
| | the error | |

Table Name—

SYS_PARAMETERS

Table Description and function—Stores system-wide parameters in a common table.

| | | Field |
|---|---|---|
| Column | | Characteristics |
| (field) Name | Description | & Indexing |
| PARAM_ID | Identifies parameter | Primary Index |
| VAR1 | First variable | |
| VAR2 | Second variable | |
| VAR3 | Third variable | |

Table Name—

CUSTOMER APPLICATION

Table Description and function—this table can have a data dictionary similar to the CUSTOMERS table, and can be used to temporarily store unapproved, unprocessed customer application data submitted by a Customer/Client Application page. When an application is processed, appropriate records can be deleted from this table.

| | | Field |
|---|---|---|
| Column | | Characteristics |
| (field) Name | Description | & Indexing |
| See CUSTOMERS | | |

Table Name—

MEMBERS APPLICATION

Table Description and function—this table has may use a data dictionary similar to PRACTICE MEMBERS, and can temporarily store unapproved, unprocessed customer application data submitted by a Customer/Client Application page. When an application is processed, appropriate records can be deleted from this table.

| | | Field |
|---|---|---|
| | | Characteristics |
| Column (field) Name | Description | & Indexing |
| See PRACTICE_MEMBERS | | |

Table Name—

CUSTOMERS

Table Description and function—Can store a unique identifier for each customer in a permanent table. Activity logged in CUSTOMER_MAINT_HISTORY table. Can be linked to third-party applications for credit terms, bill to, ship to addresses, phones and other financial data.

| Column | | | Field Characteristics |
|---|---|---|---|
| (field) Name | Description | Comment | & Indexing |
| CUSTOMER | Identifies customer | Unique identifier | Primary Index |
| | | (account number); matches | |
| | | CUSTOMER in A/R system | |
| NAME | Practice Business Name | See Practice Members for | Index |
| | | doctor data. | |
| SALES_CONSULTANT | Identifies sales consultant | | Index |
| | assigned to account | | |
| IPADDRESS1 | Internet address used to link, | Can have multiple computers | |
| | identify computers in customers | in larger offices. | |
| | office | | |
| IPADDRESS2 | Internet address used to link, | Can have multiple computers | |
| | identify computers in customers | in larger offices. | |
| | office | | |
| IPADDRESS3 | Internet address used to link, | Can have multiple computers | |
| | identify computers in customers | in larger offices. | |
| | office | | |
| IPADDRESS4 | Internet address used to link, | Can have multiple computers | |
| | identify computers in customers | in larger offices. | |
| | office | | |
| DISCOUNT_CODE | Identifies which discount code | Code must be in | Index |
| | is used to calculate prices | DISCOUNT_CODES table. | |
| | charged for this customer | | |
| PHYSICAL_ADDRESS | Street address of practice | | |
| PHYSICAL_STATE | State in which the practice | | |
| | is located | | |
| PHYSICAL_ZIP | Zip code of physical | | |
| | location of practice | | |
| SHIP_TO_ADDRESS | Address to which shipments go | | |
| SHIP_TO_STATE | State for ship to address | | |
| SHIP_TO_ZIP | Zip code for ship to address | | |
| MAIL_ADDRESS | Mailing address (for other | Literature, documents only | |
| | than shipments) | (may be a PO Box to which | |
| | | UPS & FedEx cannot ship) | |
| MAIL_STATE | Mail address state | | |
| MAIL_ZIP | Zip code for mail address | | |
| ADMINISTRATOR | Administrator, manager, etc. | | |
| | of Customer | | |

Table Name—

PRACTICE_MEMBERS

Table Description and function—This table can be linked to records in a CUSTOMERS table, and can store data pertaining to individual physicians or other health-care professionals working at or with a practice.

| | | | Field Characteristics |
|---|---|---|---|
| Column (field) Name | Description | Comment | & Indexing |
| CUSTOMER | Customer to whom the Practice | Must be in CUSTOMERS | Index - |
| | Member is associated | table already | concatenated with |
| | | | MEMBER_NAME |
| MEMBER_NAME | Name of health-care professional | Together with CUSTOMER, | With CUSTOMER |
| | or physician linked to CUSTOMER | forms unique record key | |
| MEMBER_TITLE | Title (e.g., Exec. Director) | | |
| | of member | | |
| MEMBER_MAIL_ADDRESS | Separate mailing address | | |
| | for member | | |
| MEMBER_MAIL_STATE | Member mail address state | | |
| MEMBER_MAIL_ZIP | Member mail address zip | | |
| MEMBER_LICENSE_NO | Professional license for member | | |
| MEMBER_LICENSE_EXPIRE | Expiration Date of member's | | |
| | professional license | | |
| MEMBER_DEGREE1 | First degree of member | | |
| MEMBER_DEGREE2 | Second degree of member | | |
| MEMBER_DEGREE3 | Third degree of member | | |
| MEMBER_DEGREE4 | Fourth degree of member | | |
| MEMBER_NOTES | Text/comment field | | |
| DATE_NEW | Date this member was added | | |
| | to table | | |
| DATE_LAST | Last activity date | | |

Table Name—

DISCOUNT_CODES

Table Description and function—can contain decimal values representing a unique price to be charged or discount to be granted to each customer. Any number of customers may use a discount code. When a decimal value associated with a given code is changed, the result is that all prices for all customers using that code are changed. If a customer's discount code specifies a discount value greater than allowed for a given product, the preferred inventory management system may limit a price to the maximum discount

| Column | | | Field Characteristics |
|---|---|---|---|
| (field) Name | Description | Comment | & Indexing |
| DISC_CODE | Discount code | Identifies specific | Primary Index |
| | | discount; numbering | |
| | | should be 10, 20, | |
| | | 30, etc. to allow | |
| | | for insertions in | |
| | | future, e.g, 14 | |
| DISC_VALUE | Decimal value for the | | |
| | discount to be given. | | |
| NOTES | Notes; text field for | | |
| | commentary about a | | |
| | particular discount code | | |

Table Name—

CUSTOMER_INVENTORY

Table Description and function—stores inventory at customer office. One record for each customer/SKU combination, including all that have been used in past, or which are to be used for next ordering cycle. Permanent table. Activity logged in CUSTOMER_INVENTORY_TX table.

| Column | | | Field Characteristics |
|---|---|---|---|
| (field) Name | Description | Comment | & Indexing |
| CUSTOMER | Identifies | | Index - |
| | customer | | concatenated |
| | | | with PRODUCT |
| PRODUCT | Identifies | | Indexed with |
| | product at | | CUSTOMER |
| | customer's | | |
| | site | | |
| ON_HAND_QTY | Quantity of | | |
| | an item on | | |
| | hand at this | | |
| | customer | | |
| ROP | Reorder point | When on_hand_qty | |
| | quantity | falls to or below | |
| | | this quantity, a | |
| | | new order is | |
| | | triggered for | |
| | | the product. | |
| ROQ | Quantity to | Ordering process | |
| | be ordered | uses this quantity | |
| | | when a product is | |
| | | “triggered” | |
| STATUS | Activity | Values: | Index |
| | status of | Active (default, | |
| | item | normal setting) | |
| | | NoOrder (continue | |
| | | to use up inventory, | |
| | | but no more orders) | |
| | | NoUse (do not accept | |
| | | scanned usage of | |
| | | product) | |

Table Name—

PRODUCTS

Table Description and function—identifies products available for sale at any point in time. Includes products no longer active. One record for each product/SKU/Item Number.

| | | | Field Characteristics |
|---|---|---|---|
| Column (field) Name | Description | Comment | & Indexing |
| PRODUCT_ID | Identifies product; SKU; | | Primary Index |
| | also is“item number” | | |
| SHORT_DESCRIPTION | Short description appearing on | | Index |
| | most printed outputs & screens | | |
| LONG_DESCRIPION | Long description for additional | | Index, built so each word |
| | description | | is indexed separately. |
| MANUFACTURER | Company making product; Must be | | Index |
| | in MANUFACTURERS table | | |
| MANUFACTURER_ITEM_NUMBER | Manufacturer's product | | Index |
| | identifier | | |
| STATUS | Item status | Values: | |
| | | Active (default, | |
| | | normal usage) | |
| | | NoOrder (accept usage | |
| | | scans, no orders) | |
| | | NoUse (do not accept usage | |
| | | scans; no activity; obsolete | |
| | | or discontinued) | |
| PRODUCT_CLASS | Marketing/sales classification | | Index |
| | of product | | |
| PRODUCT_GROUP | Commodity classification | | Index |
| | of product | | |
| PRODUCT_LINE | Financial reporting | | Index |
| | classification of product | | |
| SELL_START_DATE | Date that new orders for this | Prior to this date orders | |
| | product can be processed | will not be processed (new | |
| | | product so not available yet) | |
| SELL_END_DATE | Date after which new orders for | After or on this date, orders | |
| | this product cannot be | will not be processed | |
| | processed | (discontinued product) | |
| PRODUCT_PICTURE | Product Picture bit map image | JPEG or GIF | |

Table Name—

MANUFACTURERS

Table Description and function—This table stores all manufacturers whose products may be carried in the PRODUCTS table. It serves as a reference and validation table for products.

| Column | | | Field Characteristics |
|---|---|---|---|
| (field) Name | Description | Comment | & Indexing |
| MANUFACTURER_ID | Short abbreviation | | Primary Index |
| | for manufacturer | | |
| MANUFACTURER_NAME | Normal business name | | Indexed |
| | for manufacturer | | |
| DATE_ADDED | Date this Manufacturer | | |
| | was added to the table | | |

Table Name—

ORDERS

Table Description and function—stores orders generated by nightly process and/or by critical ordering process, which are then downloaded to distributor. Serves as order “header” record. Linked to ORDER DETAIL table where line items are stored. No maintenance history log table. One record for each order generated and downloaded.

| | | | Field Characteristics |
|---|---|---|---|
| Column (field) Name | Description | Comment | & Indexing |
| ORDER_NO | Order Number; unique | Generated by ordering processes; | Primary Index |
| | identifier for the order | increments SYSTEM_PARAMTER for | |
| | | order number | |
| ORDER_DATE | Date order generated | | Index |
| ORDER_TIME | Time order generated | | |
| ORDER_SOURCE | How order was generated | Sources are: | |
| | | AUTO - nightly process | |
| | | MANUAL - manual order | |
| | | entered on terminal in | |
| | | customer's office. | |
| CUSTOMER | Customer on the order | | Index |
| LINKED_SUPPLIER | Linked Supplier to whom | | Index |
| | the order was downloaded | | |
| ORDER_STATUS | Status of the order; shows | Values: GEN - generated | Index |
| | latest status only, sequence | PLACED - downloaded to | |
| | is presumed | supplier | |
| | | S_BILLED - supplier has | |
| | | invoiced Med-e-Track | |
| | | C_BILLED - system has | |
| | | converted supplier invoice | |
| | | to customer invoices | |
| STATUS_DATE | Date which status changed | | |
| SHIP_TO_ADDRESS | Address to which orders is | | |
| | to be shipped; appears on | | |
| | downloaded order data | | |
| ORDER_PRODUCT_TOTAL | Total value of order for | | |
| | product only, not including | | |
| | tax, shipping, other charges | | |

Table Name—

ORDER_DETAIL

Table Description and function—stores line item detail on ORDERS. One record for each line item on an order.

| | | | Field Characteristics |
|---|---|---|---|
| Column (field) Name | Description | Comment | & Indexing |
| ORDER_DTL_ORDER_NO | Order number to which | | Index - |
| | this detail record | | concatenated with |
| | belongs | | ORDER_LINE_NUMBER |
| ORDER_LINE_NUMBER | Line number for order. | With | |
| | | Order_Dtl_Order_no, | |
| | | forms a unique | |
| | | identifier | |
| PRODUCT | Product identifier | | Index |
| | for item ordered | | |
| ORDER_QUANTITY | Quantity of the product | | |
| | that is being ordered. | | |
| SHIP_QUANTITY | Quantity of the item | | |
| | shipped; as reflected | | |
| | on an uploaded, processed | | |
| | supplier invoice/packlist | | |
| CUSTOMER_UNIT_PRICE | Price to be charged to | | |
| | customer | | |
| CUSTOMER_UNI_SALES_TAX | Sales tax, if any to be | | |
| | charged customer | | |
| PRODUCT_ORDERED_SUBTOTAL | Value = Order_Quantity * | | |
| | Customer_Unit_price | | |
| PRODUCT_SHIP_SUBTOTAL | Value = Ship_Quantity * | | |
| | Customer Unit_Price | | |
| LINKED_SUPPLIER_UNIT_COST | Price to be paid Linked | | |
| | Supplier for this item | | |
| LINKED_SUPPLIER_PRODUCT_SHIP_SUBTOTAL | Value = Ship_Quantity * | | |
| | Linked_Supplier_Unit_cost | | |

Table Name—

LINKED SUPPLIER

Table Description and function—Stores and sets up each linked supplier, i.e., distributor that is linked into the web site. One record for each supplier that will be, is now, or has been linked at one time into Med-e-Track. Activity logged in LINKED_SUPPLIER MAINT_HISTORY. Account is linked to Supplier table in the SOLOMAN Accounts Payable subsystem.

| Column (field) Name | Description | Comment |
|---|---|---|
| SUPPLIER | Supplier's ID | Unique |
| | | identifier |
| SUPPLIER_IP_ADDRESS | IP Address where | |
| | linking process occurs | |
| OPEN_DATE | Date the relationship | |
| | was setup/started | |

Table Name—

SUPPLIER INVOICE

Table Description and function—stores uploaded invoice/pack lists from linked suppliers. Serves as “header” record for invoices. A given Order can have multiple invoices. Linked to SUPPLIER INVOICE DETAIL records which carry line item detail. Invoices uploaded from distributor reflect orders they have shipped and are then used to generate Customer invoices. The uploaded invoice data is also transferred to the Accounts Payable module of the Solomon IV software for corporate accounting/tracking. Customer invoices generated and recorded in this table are also transferred to the Accounts Receivable module.

| | | | Field Characteristics |
|---|---|---|---|
| Column (field) Name | Description | Comment | & Indexing |
| INTERNAL_INVOICE_ID | Internal, system generated | Insures unique invoice identification | |
| | invoice identifier | in case of similar supplier invoicing | |
| | | schemes/numbers | |
| ORDER | Order number which the invoice | | |
| | is a shipment/bill for. | | |
| SUPPLIER_INVOICE | Invoice identifier from supplier | Uploaded invoice data | |
| SUPPLIER_INVOICE_DATE | Date of/on supplier invoice that | | |
| | was uploaded | | |
| SUPPLIER_INVOICE_TIME | Time that supplier invoice | Invoice time may not appear in | |
| | was uploaded | supplier database. | |
| AP_DATE | Date supplier invoice data | | |
| | posted to AP tables | | |
| AP_TIME | Time supplier invoice data | | |
| | was posted to AP tables | | |
| CUSTOMER_INVOICE | Invoice ID generated by nightly | Presence indicates that nightly | |
| | process to bill customer for | process has run, generating this | |
| | shipment | separate invoice number. | |
| CUSTOMER_INVOICE_DATE | Date customer invoice generated | | |
| | by nightly process | | |
| CUSTOMER_INVOICE_TIME | Time of customer invoice | | |
| | generation process. | | |
| AR_DATE | Time | | |
| SHIPMENT | Shipment document number | May be separate ID from invoice no. | Index on this field for |
| | | | packing slip data retrieval. |
| SHIP_VIA | Shipping method; e.g., UPS Ground | | |

Table Name—

INTERNAL_INVOICE_SHIP_DETAIL

Table Description and function—This table contains shipment information for the shipment covered by the Internal Invoice. There is one record for each carton comprising the shipment covered by the Invoice. It is linked to the Internal Invoice table.

| Column (field) Name | Comment |
|---|---|
| INTERNAL_INVOICE_ID | |
| SHIP_CARTON_ID | Together with invoice id, |
| | comprises unique record ID |
| TRACKER_NO | |

Table Name—

SUPPLIER_INVOICE_DETAIL

Table Description and function—this table carries the line item level detail for invoices uploaded from the linked supplier/distributor. Some line item level detail is used to update Order data to support quick order status inquiries and track back-ordered items.

| Column (field) Name | Description | Comment |
|---|---|---|
| INTERNAL_INVOICE_ID | Identifier for | |
| | internal invoice no | |
| INTERNAL_INVOICE_LINE_NUMBER | Line number for | Together with |
| | internal invoice | Internal Invoice |
| | | identifier, |
| | | forms unique key |
| SHIPPED_PRODUCT | Product shipped | |
| SHIP_QUANTITY | Quantity shipped | |
| UNIT_PRICE | Supplier's Unit | |
| | price | |
| UNIT_TAX | Sales Tax (if any) | |
| EXTENDED_PRICE | Value = Ship_qty * | Product only |
| | Unit_Price | subtotal |
| LINE_TAX_TOTAL | Value = Ship_Qty * | |
| | Unit_Tax | |
| LINE_TOTAL_AMOUNT | EXTENDED_PRICE + | |
| | Line_Tax_total | |

Table Name—

SUPPLIER_COST

Table Description and function—Stores prices to be paid to each Linked Supplier in the system. One record for each linked supplier and SKU. Permanent table. Activity logged in SUPPLIER_COST_MAINT_HISTORY table.

| | | | |
|---|---|---|---|
| Column (field) | Description | Comment | Field Characteristics |
| Name | | | & Indexing |

Table Name—

SUPPLIER_COST_MAINT_HISTORY

Table Description and function—records changes made to SUPPLIER_COST records. One record for each field changed during an update of a given record.

| | | | |
|---|---|---|---|
| Column (field) | Description | Comment | Field Characteristics |
| Name | | | & Indexing |

Table Name—

PRODUCT_MAINT_HISTORY

Table Description and function—records changes made to PRODUCTS table. One record for each field changed during an update of a given record.

| | | | |
|---|---|---|---|
| Column (field) | Description | Comment | Field Characteristics |
| Name | | | & Indexing |

Table Name—

PRODUCT CLASS

Table Description and function—Identifies valid product classes; serves as a reference table.

| Column (field) Name | Description |
|---|---|
| PROD_CLASS_CODE | Code for product class description |
| DESCRIPTION | Text/descriptive name for product_class code |

Table Name—

PRODUCT GROUP

Table Description and function—Identifies valid product groups; serves as a reference table.

| Column (field) Name | Description |
|---|---|
| PRODUCT_GROUP_CODE | Code for product group description |
| DESCRIPTION | Text/descriptive name for Product |
| | Group Code. |

Table Name—

PRODUCT_LINE

Table Description and function—Identifies valid product lines; serves as a reference table.

| Column (field) Name | Description |
|---|---|
| PRODUCT_LINE_CODE | Code for product line description |
| DESCRIPION | Text/descriptive name for product line code |

Table Name—

CUSTOMER INVENTORY TRANSACTIONS

Table Description and function—transaction history table for activity altering data in Customer Inventory table; one record for each change recorded; main use will be recording inventory activity, although transactions will be generated for changes to status, ROP, ROQ and Notes values, i.e., non-on-hand quantity values. Each transaction affects only one data field. Transaction code indicates what update/change activity was performed, and therefore which data field was updated.

| Column | | |
|---|---|---|
| (field) Name | Description | Comment |
| TRAN_NO | Unique identifier for each | Functions like a |
| | transaction; non significant | check number. |
| TRAN_DATE | Date transaction processed | |
| TRAN_TIME | Time transaction processed | |
| TRAN_ID | Code identifying transaction | Values: TBD |
| PRODUCT | Product identifier of item | |
| | affected | |
| QTY | | |
| CUSTOMER | Customer whose inventory | |
| | data was updated/changed | |
| USER_ID | User performing transaction | |
| BEFORE_VALUE | Value of data field prior | |
| | to update action | |
| AFTER_VALUE | Value of data field after | |
| | update action | |

Table Name—

CONTACT_LOG

Table Description and function—this table accepts transactions from the consultant request function, enters and tracks them for follow-up and management purposes.

| Column (field) Name | Description |
|---|---|
| SALES_CONSULTANT_ID | ID in Sales_Consultants table. |
| REQUEST_DATE | Date customer initiated request |
| REQUEST_TIME | Time customer initiated request |

Table Name—

CUSTOMER_USERS

Table Description and function—This table stores information about each user at a customer's site. There are two classes of users, supervisor and staff. Only a user with supervisor rights can add new users. The web page “hard-wires” who the customer is so customer users are kept associated with the correct customer.

| | | | |
|---|---|---|---|
| Column (field) | Description | Comment | Field Characteristics |
| Name | | | & Indexing |

Table Name—SALES CONSULTANTS

Table Description and function—This table stores data about each Sales Consultant. It is essentially a reference table.

| Column (field) Name | Description |
|---|---|
| SALES_CONSULTANT_ID | Unique identifier * |
| | record key |
| CONSULANT_SHORT_NAME | Short name, nicknemame, |
| | initials to be used on |
| | screens, reports |
| CONSULTANT_FULL_FIRST_NAME | First name of consultant |
| CONSULTANT_LAST_NAME | Last name of consultant |

It should be obvious to one skilled in the art that the preferred inventory management system allows inventory tracking and management through a combination of manual, semi-automated, and automated means. The preferred inventory management system also allows a manager to purchase in bulk and take advantage of promotions and other special offerings, thus reducing inventory costs. In addition, the preferred inventory management system reduces the amount of inventory which must be kept on-hand by accurately modeling and predicting inventory needs. The preferred inventory management system further provides customers with the ability to review new equipment, communicate with each other, and buy and sell excess inventory, refurbished equipment, and the like.

While the preferred embodiment and various alternative embodiments of the preferred inventory management system have been disclosed and described in detail herein, it may be apparent to those skilled in the art that various changes in form and detail may be made therein without departing from the spirit and scope thereof, including applying the preferred inventory management system to fields other than healthcare.

Thus, the preferred inventory management relates to an inventory management system comprising:

one or more computers;

one or more databases residing on said computers, in which inventory information is stored;

client software providing an interface to said database and performing administrative functions;

a user identification subsystem;
a first subsystem, through which new products can be added to said database, and which enables proper accounting of restocked products within said database; and
a second subsystem, which accounts for products within said database as such products are removed from inventory;
a third subsystem, wherein the third subsystem allows at least one vendor to access the database; and
a fourth subsystem, wherein the fourth subsystem allows for automated product identity data entry.

In one aspect of the preferred inventory management system, said one or more of said subsystems are comprised of an optical reader which can read specially coded information on an object or person.

In another aspect of the preferred inventory management system, said one or more of said subsystems are comprised of an electronic device for scanning wirelessly accessible-identifiers associated with objects or persons.

In an alternate aspect of the preferred inventory management system, said user identification subsystem is comprised of a biometric identification device.

In a further aspect of the preferred inventory management system, said client software permits registration and removal of individual users, and modification of user information.

In another aspect of the preferred inventory management system, said client software allows users to be classified into groups, and where permissions or roles are assigned to such groups.

In yet another aspect of the preferred inventory management system, said client software allows products to be grouped, allows restrictions to be placed on distribution of such products, permits recording of information when a product belonging to a group is dispensed, and allows printing of product specific or group specific information for inclusion with each product removed from inventory.

In an alternate aspect of the preferred inventory management system, said client software monitors inventory levels and reports anticipated shortages.

In a further aspect of the preferred inventory management system, said client software monitors inventory levels and generates orders to cover anticipated shortages.

In yet a further aspect of the preferred inventory management system, said client software allows users to order new products or to supplement inventory when desired.

In another of the preferred inventory management system, said client software allows users to specify a price for goods for sale within an inventory.

The preferred inventory management further relates to a vendor managed inventory system, comprising: one or more suppliers maintaining inventory utilizing an inventory management system; one or more customers maintaining inventory utilizing an inventory management system; a central server, which facilitates communications and inventory management between said customers and said suppliers; and, a redundant data connection between said suppliers, said customers, and said central server.

In one aspect of the preferred inventory management system, said central server receives inventory information from customers and suppliers, anticipates inventory shortages, generates orders to cover such shortages, selects suppliers and products for such orders, places orders with selected suppliers, and monitors order status.

The preferred inventory management additionally relates to an inventory distribution system comprising: a vending machine; a computer connected to said vending machine; software running on said computer; a printer; a user identification subsystem; and a data entry subsystem.

In one aspect of the preferred inventory management system, said user identification subsystem is comprised of a biometric scanner, RFID reader, barcode scanner, keyboard, touch sensitive display, or combinations thereof, and through which users can positively identify themselves to said computer via said software.

In another aspect of the preferred inventory management system, said data entry subsystem is comprised of an active or passive user interface, and through which users can request dispensation of certain products.

In a further aspect of the preferred inventory management system, said printer prints product information when requested and as necessary to satisfy applicable regulations.

In an alternate aspect of the preferred inventory management system, said inventory distribution system further comprises a central server and a redundant data connection between said vending machine and said server.

In a preferred embodiment, said computer monitors distribution of products contained within said vending machine, transmits such distributions to said server via said redundant data connection, and through which said server can notify a vending machine service provider of any inventory shortages.

The preferred inventory management also relates to an automated method of inventory management involving the steps of: accounting for received products in an inventory; monitoring products as such products are removed from an inventory; calculating trends based on the frequency with which products are used; determining optimal product quantities for each order, such that shipping costs are reduced and price points for different quantities are taken into account while also reducing expenditures. ordering additional stock as needed; tracking said orders; calculating order fulfillment trends based on delivery times from each supplier and for each product; and, determining preferred suppliers based on such order fulfillment trends.

In one aspect of the preferred inventory management system, said step of accounting for received products in an inventory involves electronically reading documentation supplied with each package and automatically updating inventory information to reflect package contents.

In another aspect of the preferred inventory management system, said step of monitoring products as such products are removed from an inventory involves electronically reading a product identifier associated with a product or group of products.

In a further aspect of the preferred inventory management system, said automated inventory management method further includes the step of identifying a user removing products from an inventory by electronically retrieving an identifier from said user.

In addition, the preferred inventory management relates to an automated order fulfillment method, comprising the steps of: receiving an availability and pricing request from a customer for one or more products; determining acceptable alternatives for said products based on customer preferences; determining quantities available, pricing, quantities necessary for a price break, and anticipated delivery times from one or more suppliers to meet said request, including any acceptable alternatives; selecting products, product quantities, and suppliers that provide the most value while still meeting customer inventory needs; generating product pick and pack slips for each supplier; recording products as they are “picked” from a supplier inventory; recording products as they are packed into shipping packages; generating package packing slips and shipping labels; correlating shipping and packing information; shipping said packages; and tracking said shipments.

In one aspect of the preferred inventory management system, said picked products are recorded by electronically scanning identifiers associated with such products.

In a preferred embodiment, said picked products are recorded by electronically scanning identifiers associated with such products using a handheld computing device, to which a barcode scanner is attached.

In another aspect of the preferred inventory management system, said step of recording products as they are packed further includes the step of scanning an identifier associated with a shipping package prior to scanning individual items packed into a shipping package.

In a further aspect of the preferred inventory management system, said packing and shipping labels include a machine readable identifier.

The preferred inventory management further relates to a vendor managed inventory and group purchasing system, comprising: one or more servers; one or more databases running on said servers; client software running on one or more computers at a customer site, which is capable of monitoring customer inventories and reporting such information to said server via a redundant data communications connection; client software running on one or more computers at a supplier site, which is capable of monitoring product quantities on hand and supports multiple product prices depending on order quantities, and which is capable of transmitting such information to said server via a redundant data communications connection; and software running on said server that consolidates customer orders such that customer costs may be decreased by leveraging the consolidated order quantities.

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the inventive subject matter as described herein.

We claim:

1. A system for managing assets of an enterprise, comprising:
a. a plurality of managed asset units, each tagged with a unique identifier;
b. a first asset reader, having an associated first location coverage area, for reading a tagged asset;
c. a first interface for entering or reading identity information of a user at the first location;
d. a second asset reader, having an associated second location coverage area, for reading a tagged asset;
e. a second interface for entering or reading identity information of a user at the second location;
f. at least one data server, configured for:
i. storing the unique identifiers and associated data describing the asset corresponding thereto,
ii. storing data relating to a plurality of asset units,
iii. storing identity information, and permissions, roles, or both assigned to at least one user, and
iv. determining location information for an asset unit based on the coverage areas of the asset readers; and
g. a client device which is connected to the data server, and includes a display device configured to display:
i. a plurality of user-selectable data queries corresponding to stored asset unit data, and
ii. search results for stored asset unit data that corresponds with a user-selectable data query.

2. The system of claim 1, wherein each managed asset unit is tagged with an RFID tag.

3. The system of claim 1, wherein each user is a company employee.

4. The system of claim 1, wherein asset unit data comprises manufacturer, model, serial number, description, expected life cycle, cost, in-stock date, availability in stock, repair history, damage history, in-use date, out-of-service date(s), remaining life cycle predicted, date returned, date transferred, obsolescence date, sale date, total quantity in stock, or a combination thereof.

5. The system of claim 1, wherein the at least one data server is additionally configured for providing an alert to the user or another member of the enterprise.

6. The system of claim 5, wherein the alert to the user or another member of the enterprise comprises information relating to the user's lack of permission or role, improper location of an asset unit, lack of a required asset unit, request for additional data, or a combination thereof.

7. A method for managing assets of an enterprise, comprising the steps of:
a. providing a plurality of managed asset units, each tagged with a unique identifier, wherein the unique identifiers, associated data describing the asset corresponding thereto, and data relating to a plurality of asset units are stored in at least one data server;
b. reading an asset tag associated with a managed asset unit with a first asset reader having an associated first location coverage area;
c. entering or reading identity information of a user at the first location, wherein the identity information, and permissions, roles, or both assigned to at least one user are stored in the at least one data server;
d. reading an asset tag associated with a managed asset unit with a second asset reader having an associated second location coverage area;
e. entering or reading identity information of a user at the second location; and
f. determining location information for an asset unit based on the coverage areas of the asset readers;
g. outputting a plurality of user-selectable data queries corresponding to stored asset unit data, search results for stored asset unit data that corresponds with a user-selectable data query, or a combination thereof.

8. The method of claim 7, wherein each managed asset unit is tagged with an RFID tag.

9. The method of claim 7, wherein each user is a company employee.

10. The method of claim 7, wherein asset unit data comprises manufacturer, model, serial number, description, expected life cycle, cost, in-stock date, availability in stock, repair history, damage history, in-use date, out-of-service date(s), remaining life cycle predicted, date returned, date transferred, obsolescence date, sale date, total quantity in stock, or a combination thereof.

11. The method of claim 7, additionally comprising the step of providing an alert to the user or another member of the enterprise.

12. The method of claim 11, wherein the alert to the user or another member of the enterprise comprises information relating to the user's lack of permission or role, improper location of an asset unit, lack of a required asset unit, request for additional data, or a combination thereof.

13. A system for tracking shopping cart assets, which comprises:
(a) an RFID tag affixed to a shopping cart;
(b) a plurality of RFID antennae located in a store and configured to track the shopping cart as it moves throughout the store and to record time and location events during the use of the shopping cart by a customer;
(c) an RFID antenna located at a checkout area; and
(d) a device or system for synchronizing during checkout point-of-sale data and the RFID tag on the cart.

14. The system of claim 13, wherein said recorded time and location events are processed to yield one or more customer-associated time and location reports relating to the use of the shopping cart by the customer.

15. The system of claim 13, wherein said time and location events are determined at about 15 second intervals.

16. The system of claim 13, wherein said time and location events are determined at about 5 second intervals.

17. The system of claim 13, wherein said time and location events are determined at about 1 second intervals.

18. A method for tracking shopping cart assets, comprising the steps of:
(a) reading and recording the time a shopping cart having an affixed RFID tag is placed in use by a customer;
(b) reading and recording time and location events for the shopping cart as it moves throughout a store, using a plurality of RFID antennae located in the store and configured to track the use of the shopping cart by a customer;
(c) reading and recording the time the shopping cart reaches a checkout area, using an RFID antenna which reads in the checkout area; and
(d) synchronizing point-of-sale data with the RFID tag on the cart during customer checkout.

19. The method of claim 18, wherein said recorded time and location events are processed to yield one or more customer-associated time and location reports relating to the use of the shopping cart by the customer.
